(19) United States
(12) Patent Application Publication
(10) Pub. No.: US 2005/0160104 A1
(43) Pub. Date: Jul. 21, 2005

(54) System and method for generating and deploying a software application

(75) Inventors: Belligundu Meera, Greenbelt, MD (US); Mathew Gower, Greenbelt, MD (US); Michael Smolyak, Greenbelt, MD (US); David Sills, Greenbelt, MD (US); Troy Carter, Greenbelt, MD (US)

Correspondence Address: BURNS DOANE SWECKER & MATHIS L L P, POST OFFICE BOX 1404, ALEXANDRIA, VA, 22313-1404, US

(73) Assignee: DataSource, Inc., Greenbelt, MD (US)

(21) Appl. No.: 10/893,582

(22) Filed: Jul. 19, 2004

Related U.S. Application Data
(60) Provisional application No. 60/536,991, filed on Jan. 20, 2004.

(51) Int. Cl. G06F 7/00

(52) U.S. Cl. 707/100

(57) ABSTRACT

The present invention is directed to systems and methods for providing a software developer's toolbox for generating and deploying a software application. While several preferred embodiments are directed toward a modular toolbox for generating and deploying web-based enterprise applications deployable onto J2EE-compliant servers, all embodiments are not so limited and can be directed toward the generation and deployment of software applications that are compatible with non-Internet networks such as private networks, local networks, and intranets and further are compatible with non-networked applications including Windows and non-Windows operating system applications. Further, exemplary embodiments can provide for the generation and deployment of software applications written in non-Java code.

### CROSS-REFERENCE TO RELATED APPLICATION

This application is based upon and claims priority from U.S. provisional patent application No. 60/536,991, filed Jan. 20, 2004, the contents of which being incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights, whatsoever.

### BACKGROUND OF THE INVENTION

1. Field of the Invention

The present invention relates generally to software application tools and, more specifically, to systems and methods for generating and deploying enterprise applications compatible with the Java™ 2 Platform, Enterprise Edition standard for Internet or intranet based applications.

2. Description of the Related Art

The implementation and use of the Internet, intranets, and local networks has exploded in recent years, with a large number of diverse applications being written and deployed on these various networks for both public and private use, with a concurrent number and diversity of data, files, information systems, and databases being also available for both query and writing. In the interest of providing broad and easy access to the Internet and other large networks by a large numbers of users, a multitude of conventions, standards, and procedures have been adopted to permit both users and application developers more or less seamless access and use of the networks and their related applications and files.

One such standard for the generation of software applications to run smoothly on the World Wide Web and the Internet is the Java™ 2 Platform, Enterprise Edition (J2EE), developed by Sun Microsystems, Inc. J2EE is not a programming language, such as the Java™ 2 Platform, Standard Edition, with which to write and deploy distributed network-compatible applications, including Web-based services. Instead, it is a standard, or specification, for ensuring that diverse J2EE-compliant applications and databases can operate successfully across a multitude of computers, networks, servers, and browsers.

J2EE-compliant software (the “application server”) supplies the infrastructure required in enterprise software. For example, an application server may provide the infrastructure to communicate with clients over a network using the Hypertext Transfer Protocol (HTTP) made popular by its use in browser software; to persist data to databases over a network using proprietary communications protocols; to maintain data integrity throughout business processing and data persistence, even in the event of errors; to support asynchronous messaging for client convenience; to manage concurrent requests without data overlap, unwanted sharing, or corruption; and so forth. The J2EE specification dictates the services to be provided as well as the interfaces to these services, giving application developers a well-understood supply of services to use in the creation of their business and domain logic.

While a consistent standard makes sense for access to and use of a diverse, international network, the standard itself is very complex, detailed, and interrelated, entailing more than fifteen separate specification documents. Accordingly, there exists a need for a J2EE developer's toolbox system that eases the process of creating applications using J2EE-specified service interfaces and thereby deployable on J2EE-compliant application servers. There is a particular need for a business solution toolbox to enable a user who is not conversant in Java or J2EE standards to generate and deploy web-based business enterprise solutions that can be deployed on a J2EE-compliant application server.

### SUMMARY OF THE INVENTION

The present invention is directed toward a computer-based system and method for generating a software application, including defining entities, including entity attributes and relationships, for access by the generated software application; defining database queries to be included in the generated software application for searching application data; defining application users, roles, and groups for controlling user access to software application generation and/or execution; defining business logic for directing the processing of the generated software application; and generating software application code in conformance with the defined business logic.

In accordance with one aspect of the present invention, a computer-based method is directed toward generating a software application, including providing an extensible user interface framework for generating a software application; and providing a computer to define entities, including entity attributes and relationships; define database queries to be included in the generated software application for searching application data, including the attributes of the defined entities; define application users, roles, and groups for controlling user access to application generation modules and generated application methods; define business logic for directing the processing of the generated application; and generate software application code in conformance with the defined business logic.

Exemplary embodiments of the invention are directed toward a computer-based system for generating a software application, including an entity builder module for defining entities, entity attributes, and entity relationships; a search builder module for defining database queries to be included in the generated software application for searching application data; a security manager module for defining application users, roles, and groups; a business logic builder module for defining business logic for directing the processing of the generated application and for generating software application code in conformance with the defined business logic; and a deployment module for deploying the generated software application code.

Additional embodiments include a computer system having a networked server architecture, including a client server, said client server providing a graphical interface between an application user and a software application; an application server, said application server configured to receive one or more generated software applications and further configured to communicate with a client server; and a database server, said database server comprising at least an enterprise information system, said database server configured to communicate with the application server.

### BRIEF DESCRIPTION OF THE DRAWINGS

These and other objects and advantages of the present invention will become more apparent and more readily appreciated from the following description of the preferred embodiments, taken in conjunction with the accompanying drawings, wherein like reference numerals have been used to designate like elements, and wherein:

FIG. 1 shows a component diagram of a software application generation and deployment system configured in accordance with exemplary embodiments of the present invention.

FIG. 2 shows the horizontally-layered software application structure generated and deployed according to an exemplary embodiment.

FIG. 3 shows the typical layers of a J2EE application and the corresponding modules of the present system for generating the layers.

FIG. 4 shows the modular architecture of an exemplary system for generating and deploying software applications in accordance with embodiments of the present software-based system for generating software applications.

FIG. 5 shows a graphical user interface screen by which a user can select the desired application generation module.

FIG. 6, consisting of FIGS. 6A and 6B, shows the server-based architecture for the generation, deployment, and use of a software application according to exemplary embodiments. FIG. 6B shows more of the detail of the application generation and deployment toolbox on a user's computer.

FIG. 7 shows a block flow chart of an exemplary method for generating and deploying a software application.

FIG. 8 shows a block diagram of the code generation proceedure.

FIG. 9 shows a graphical user interface menu of application project tools for generating and deploying a software application.

FIG. 10 shows a graphical user interface menu for creating a new project/application to be generated and deployed by exemplary embodiments.

FIG. 11 shows a graphical user interface menu for creating a new entity with the Entity Builder Module.

FIG. 12 shows a graphical user interface menu for displaying and editing the characteristics of an entity with the Entity Builder Module.

FIG. 13 shows a graphical user interface menu for defining an external database to which the application can connect with the Entity Builder Module.

FIG. 14 shows a graphical user interface menu for displaying the defined external databases and their characteristics with the Entity Builder Module.

FIG. 15 shows a graphical user interface menu for deploying an entity definition onto the application system database with the Entity Builder Module.

FIG. 16 shows a graphical user interface menu for building a database query with the Search Builder Module.

FIG. 17 shows a graphical user interface menu for displaying exemplary list definitions with the List Builder Module.

FIG. 18 shows a graphical user interface menu for creating a presentation list with the List Builder Module.

FIG. 19 shows a graphical user interface menu for defining element and ID rules with the Identification Builder Module.

FIG. 20 shows a graphical user interface menu for establishing roles for users of an application with the Security Manager Module.

FIG. 21 shows a graphical user interface menu for selecting tools and actions available through the Business Logic Editor.

FIG. 22 shows a graphical user interface menu for building new business components with the Business Logic Builder Module.

FIG. 23 shows a graphical user interface menu for displaying a new business component and for building new methods within a business component with the Business Logic Builder Module.

FIG. 24 shows a graphical user interface menu for automatically generating new methods within a business component with the Business Logic Builder Module.

FIG. 25 shows a graphical user interface menu for adding a wrapper method to a business component with the Business Logic Builder Module.

FIG. 26 shows a partial logical tree view of the methods and business components of an application generated in accordance with exemplary embodiments.

FIG. 27 shows a graphical user interface menu for displaying the data types contained in each data object and for inserting a selected data object in the script of the application with the Business Logic Builder Module.

FIG. 28 shows a graphical user interface report builder menu available to the application generator for developing reports to be generated, printed, and/or exported by the generated application.

### DETAILED DESCRIPTION OF THE PREFERRED EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention. For instance, a high level familiarity with the basic components of the J2EE platform, e.g., Enterprise JavaBeans, is presumed.

Exemplary embodiments are directed to systems and methods for providing a software developer's toolbox for generating and deploying software applications. While several preferred embodiments are directed toward a modular toolbox for generating and deploying web-based enterprise applications compatible with the J2EE standard, all embodiments are not so limited and can be directed toward the generation and deployment of software applications that are compatible with non-Internet networks such as private networks, local networks, and intranets and further are compatible with non-networked applications including Windows and non-Windows operating system applications. Further, exemplary embodiments can provide for the generation and deployment of software applications written in non-Java code. Details of exemplary embodiments, including embodiments directed toward generating software applications compatible with the J2EE standard, can be found in the publication Jetson™ Toolbox, Version 1.0, Developers' Guide, ©2004 DataSource, Inc., the contents of which are incorporated herein by reference.

Exemplary embodiments for generating and deploying software applications can be viewed as a plurality or set of software tools or modules that are utilized to (1) describe, in high-level language, business requirements for the application to be generated; (2) generate the software code to actually execute or fulfill the aspects of the business or enterprise application; and (3) deploy the generated application to one or more computers or servers for ultimate execution. Each of the functional modules can be viewed as plug-in tools from the perspective that the modules need not always be executed in a particular sequence to generate and build the applications. In fact, one or more modules can be processed, and the user can defer processing of the remaining modules as the enterprise application concepts are further refined, as time becomes available, or any number of other reasons. Additional modules and plug-in tools not presented here are envisioned to be able to be added later, and the modular aspect of exemplary embodiments permits users to develop their own modules to add to those presented here to customize the generation of software applications according to the specific needs of each user. The modular tools discussed herein permit the user to generate and deploy an enterprise software application which follows targeted enterprise logic while divorcing the user from the typical skill set requirements associated with drafting and deploying a software application on an application server.

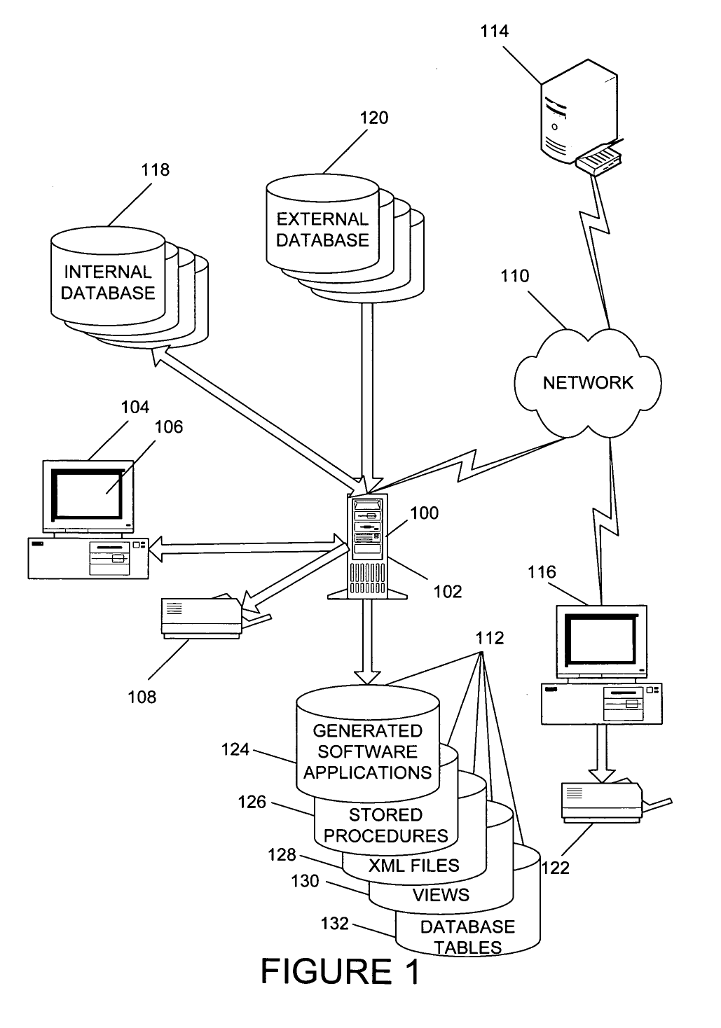

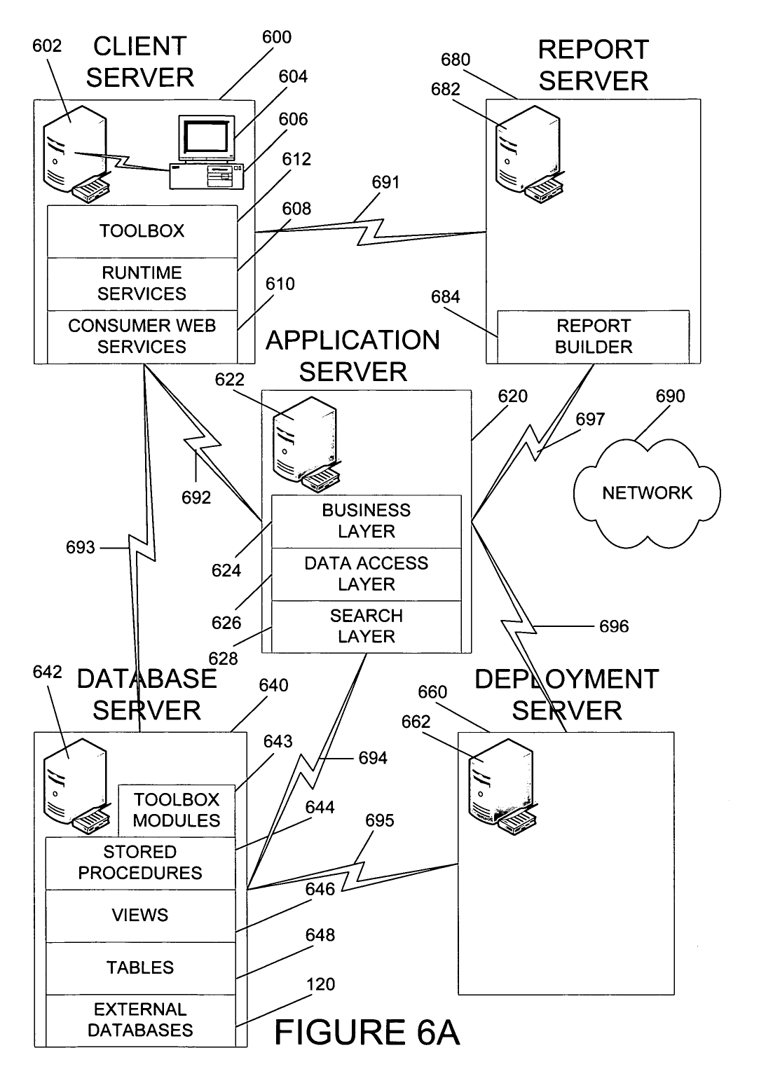

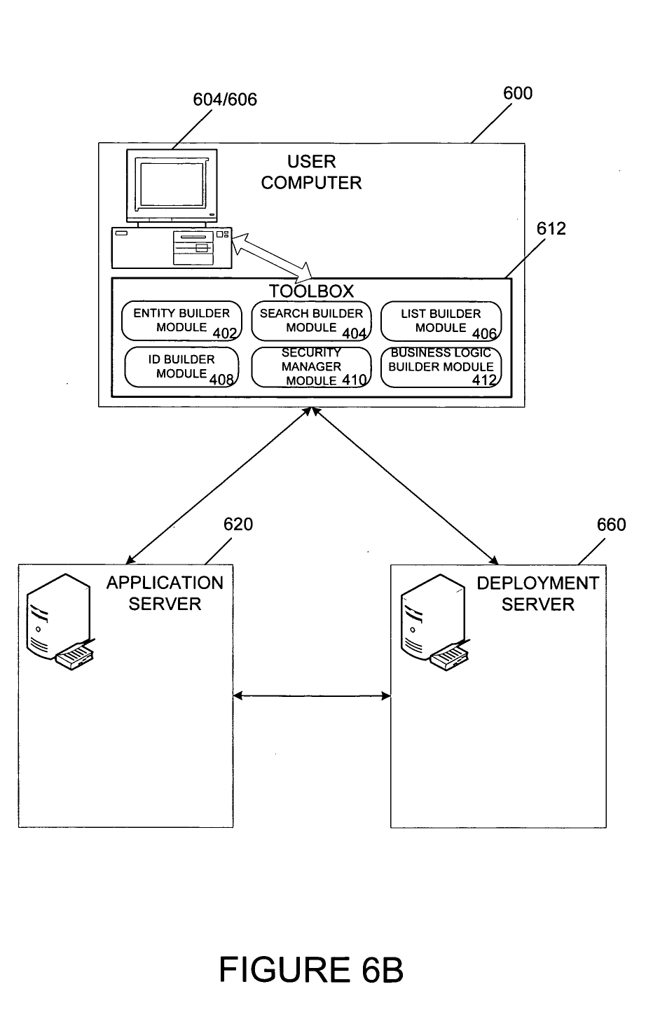

Referring now to FIGS. 1 and 6A, there is illustrated a component diagram of a software application generation and deployment system configured in accordance with an exemplary embodiment of the present invention. As can be seen from FIG. 1, exemplary embodiments are implemented on a computer 100 having a processor 102. FIG. 6A shows the generation, application, and execution components of exemplary embodiments in a server-based architecture and will be discussed in more detail below. While a personal computer 100 with a single processor 102 is shown in FIG. 1, exemplary embodiments can operate on any number of computers 100 having one or more processors 102 each for the generation and deployment of software applications. The computer(s) 100 can be a personal computer, a main frame computer, a server, a Bluetooth device, and the like and can communicate across one or more networks 110 for ultimately generating and deploying a computer-based application. The software-based toolbox modules designed to generate and deploy computer software applications can be encoded on computer-readable media, such as memory, removable disks, disk drives, and/or the like accessible by the computer 100. These software modules can also be viewed as computer program products which, when executed on a computer, implement a software application generator by performing the steps of the exemplary application generation process. Exemplary embodiments can utilize a plurality of internal and external databases 118 and 120 for building software applications. Internal meta-data databases 118 provide an internal meta-model architecture for providing speed and flexibility to the application generation process while simplifying the definition and management of the application's data requirements. Existing external databases 120 can be seamlessly integrated into the application, eliminating any incongruities between different relational databases needed by the application. Software code, objects, components, and the like generated by the system can be output to one or more databases 112.

The process of application generation by exemplary embodiments is accomplished in part with the developer/user inputting descriptions of data elements, business logic, and output form elements into the application generation systems. Each description is stored in database tables 132, either as simple data values or in Extensible Markup Language (XML) format. The model built by exemplary embodiments from these descriptions becomes the basis for generation of application-specific code. Modules of exemplary embodiments generate, compile, and deploy the applications to designated servers 114 for ultimate use and execution.

Each toolbox module of the application generation system presents a graphical user interface (GUI) 106 that simplifies the task of describing and selecting application requirements and options. XML files and database tables created and stored by each module in one or more databases 112 can be utilized during deployment and execution to fully describe a portion of the application architecture generated by a particular module. The exemplary modules permit the user to define multiple enterprise applications by designating for each application a dedicated database 112 and a group of middle-tier application servers 620 to be used for generating and ultimately executing the enterprise applications. The results of the application generation/deployment process can be displayed to the user on a GUI 106 and/or on a printer 108. The application development user can work with exemplary embodiments directly with the computer 100 or by means of an alternate computer 104 connected by known means to the computer 100. The generated application can be deployed over one or more networks 110 onto one or more remote servers 114 for ultimate usage by means of a remote computer 116, with application results being displayed on a GUI to the user and/or output to a printer 122.

While the application generation/deployment system is envisioned herein to have separate and remote application developers and application users working on their respective computers 104 and 116 across one or more networks 110, the system is not limited to this configuration. In an alternate embodiment, the application developer and the application user can be the same person and/or can utilize the same resources with which to generate and to access or execute the application. In this alternate embodiment, both classes of users could utilize the Client Server 600 environment to first generate the application and second execute the generated and deployed application. In this manner, an enterprise could both develop an application and deploy it for usage within the enterprise. In such an embodiment, for example, the Runtime Services 608 could be equally available to both the developer and the application user.

Exemplary embodiments provide application development and runtime features that utilize the Hypertext Transfer Protocol (HTTP) and Simple Object Access Protocol (SOAP) for communication between different application layers. By using standard Internet protocols in some of the embodiments, the application generation and deployment process can perform well across both local and wide area networks, such as the World Wide Web, and can perform well in many firewall environments without need for modification of existing firewall security settings.

FIG. 6A shows a server-based architecture for the generation, deployment, and use of a software application across one or more networks according to exemplary embodiments. While the computer processing utilized for the generation, deployment, and use of a software application can be performed on a single computer in one geographic location, embodiments are not so limited; and exemplary embodiments are shown in FIG. 6A where the processing functionality can be distributed across multiple servers (such as server 620), computers (such as computer 604), and processors (such as 606). The various servers communicate among themselves across one or more networks 690 via communication links (such as communication link 692). While the Internet has been discussed above as a network 690 across which software applications can be generated and deployed by exemplary embodiments, other networks, including local area networks, intranets, and the World Wide Web can also be utilized. The communication links (such as communication link 693) can be any known means of transmitting and receiving electronic signals, including radio waves, hard-wired telephone lines, fiber optics, and the like. Further, in those embodiments where two or more of the functional servers shown in FIG. 6A are contained within a single server or computer, the communication links can include the circuit boards and components within the single server or computer.

While the Report Server 680 is shown in FIG. 6A as a separate server in communication with the Client Server 600 and the Application Server 620, the functions of the Report Server 680, including print, report, and form generation, can be included in Business Layer 624 of the Application Server 620. Correspondingly, in alternate embodiments, the functionality of other servers can be combined to eliminate the network communication paths, such as those paths shown as elements 691 and 696. For example, the deployment/undeployment functions of the Deployment Server 660 can be incorporated into the Client Server 600 and/or the Application Server 620 without detracting from the functionality of exemplary embodiments.

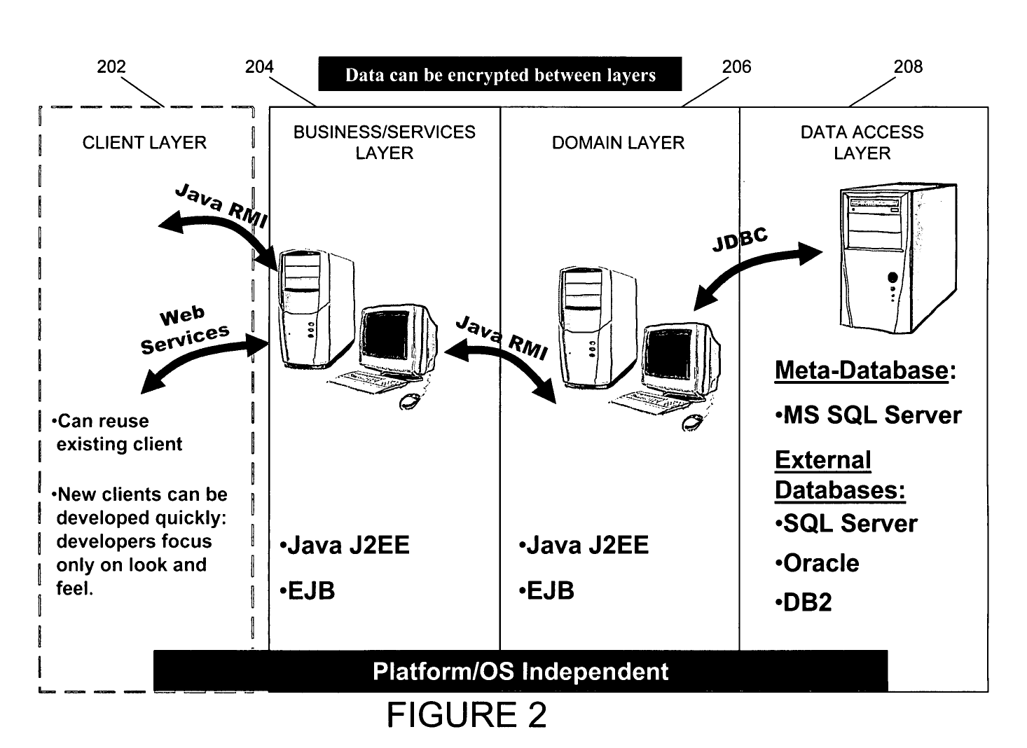

A preferred embodiment of the present system and method for generating and deploying software applications is designed to target all layers of a typical J2EE application, which is shown in FIG. 2 in a horizontally-layered structure. The Data Access Layer 208 is concerned with communication with the databases 112, 118, and 120 and with persistence concerns. It can be viewed as providing a service to the Domain Layer 206, which is concerned with maintaining an entity data model, as will be discussed more thoroughly below. In this way, the Domain Layer 206 need not contain software code for database persistence; it simply uses the Data Access Layer 208 as a “black box” for accessing the data. The Business Logic/Services Layer 204 does not require software code regarding the location of the entities and other data nor how the data types are related. The Business Logic/Services Layer 204 similarly uses the Domain Layer 206 as a “black box” to seamlessly access the needed data and therefore can focus on implementing the details of the required business logic. The Client Layer 202 is concerned with the presentation of information to the client/user and communication with the application server hosting the application.

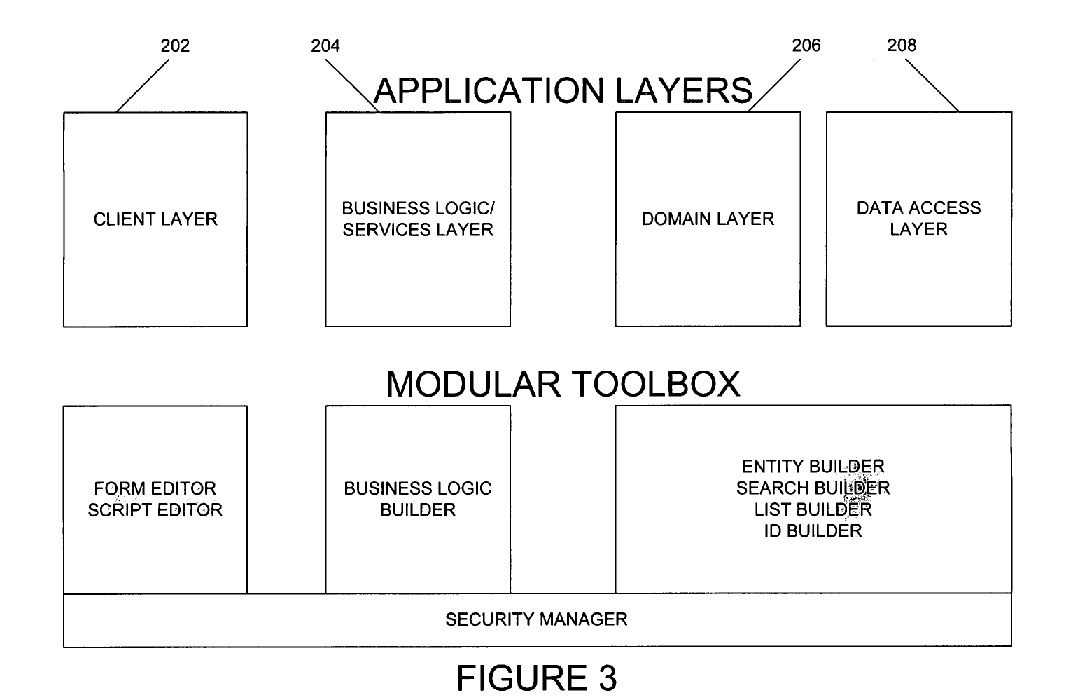

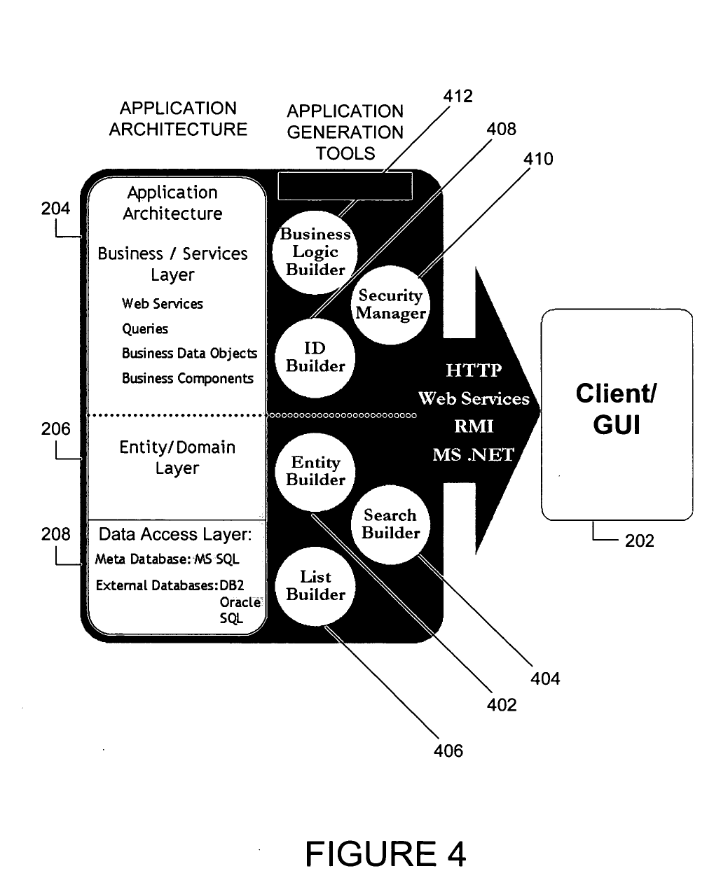

The application generation and deployment is accomplished with a software toolbox of modules, each designed to perform a finite portion of the generation and deployment process. FIG. 3 shows another perspective of the layered structure of a generated application, the layers of which are aligned with the generation tools of exemplary embodiments which target the respective application layers and which will be discussed in more detail below in conjunction with FIG. 4. While FIGS. 2 and 3 have been described in the context of generating a structured application that is deployable on a J2EE-compliant application server, exemplary embodiments are not limited to such applications; and the features of exemplary embodiments can be directed to generate and deploy many types, structures, configurations, and server-compatible software applications.

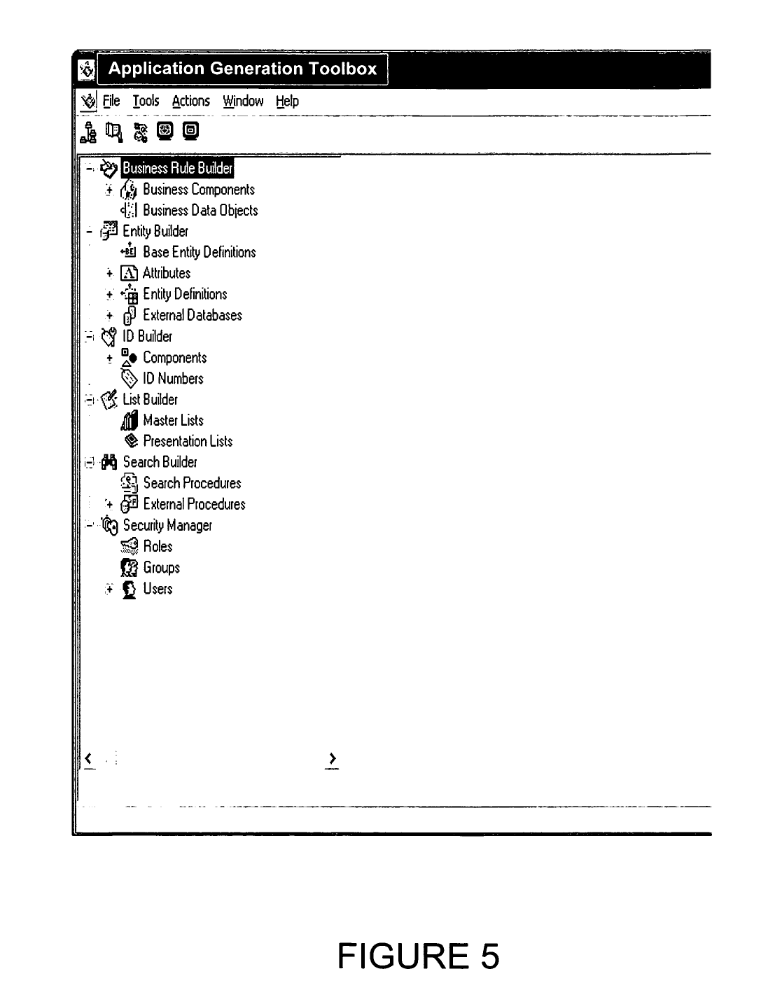

Referring now to FIG. 4, there is shown the modular architecture of an exemplary system for generating and deploying software applications in accordance with embodiments of the present software-based system for generating software applications. Each of the software-based modules shown in FIG. 4 can be viewed as means by which exemplary embodiments generate the functional aspects and data objects of a software application for ultimate generation and deployment as a usable application that is compatible with the computers, networks, and standards for which the application is being designed. FIG. 5 shows an exemplary graphical user interface (GUI) image presented to the user upon initiation of the present embodiment for selection of the desired module with which to initiate or continue generation of the targeted software application.

FIG. 6B shows the toolbox configuration of exemplary embodiments, with six plug-in modules 402-412 on the user's computer 604, such that the user can select, by means of the computer/processor 604/606, the particular build modules with which to generate the user's desired application, and in which particular order. While six modules are shown in FIGS. 4 and 6B, additional modules can be added without detracting from exemplary embodiments to add or dissect functions of the application generation/deployment system. Similarly, several functions can be combined in fewer than six modules to generate and deploy software applications according to exemplary embodiments.

Through the various modules of the application generation/deployment system, the user can select and apply templates, accepting one or more filled-in fields of the templates and/or entering information in one or more templates and thereby building the targeted application with the user's desired logic. The user's computer 604, either directly or through a Client Server 600, communicates with the Application Server 620 to generate and compile the software code and objects for the user's application. A Database Server 640 can also be communicated with to access script, code, and objects with which to compile the code of the end application. Finally, a Deployment Server 660 and its deployment modules can be accessed to assist in deploying the objects, components, software modules, applications, and the like generated by the application generation modules 402-412 for ultimate use and/or execution by an application user. The generated application can be deployed onto the Application Server 620 for ultimate access and/ or execution by a user, but exemplary embodiments are not limited to the generated code residing on the Application Server 620. For example, the generated code can reside on the Client Server 600 and/or can reside on one or more databases for access and loading upon application execution.

Generation and ultimate deployment of a user application often begins with the user planning and modeling the application by determining what input data is desired or needed, the business logic the application is to follow, and the desired output of the application. The graphical user interfaces, menus, prompts, and objects of exemplary embodiments guide the user from the planning and modeling stage through the steps of the generation and deployment of the finished application. In short, exemplary embodiments provide a bridge from the business logic of an enterprise application to a coded application for carrying out the enterprise logic. The present application generation/deployment system envisions that a targeted user application can be a fully functional enterprise application or merely an application module to be called by or to be an integral part of another application.

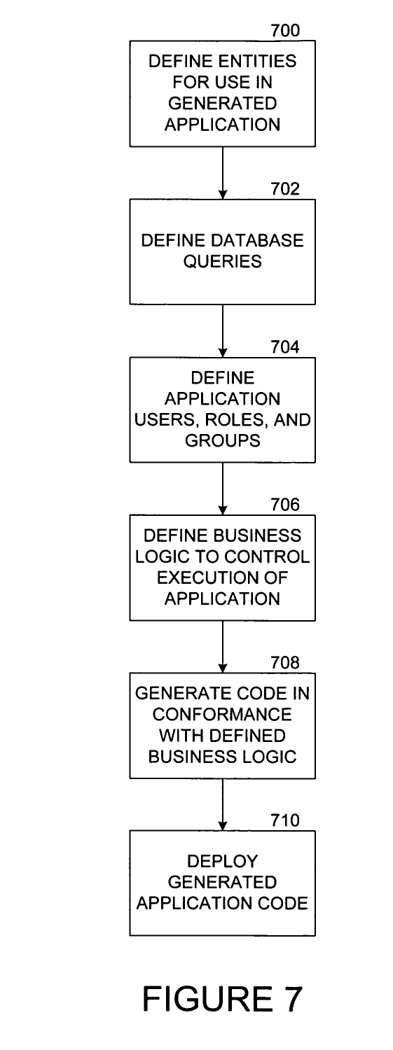

The process of generating and deploying a software application can be seen in FIG. 7 where the multiple steps are shown leading to the deployment of the generated application. At the outset, it should be noted that the steps shown in FIG. 7 can be performed in any sequence, and steps can be performed multiple times. One caveat is that at least one of steps 700 through 706 is typically performed before step 708, and that step 708 typically is executed at least once before step 710 is performed.

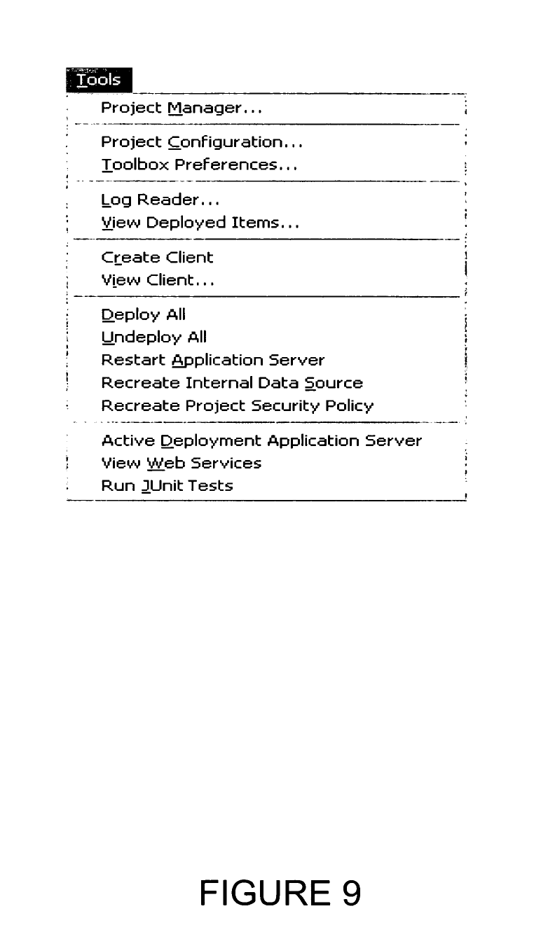

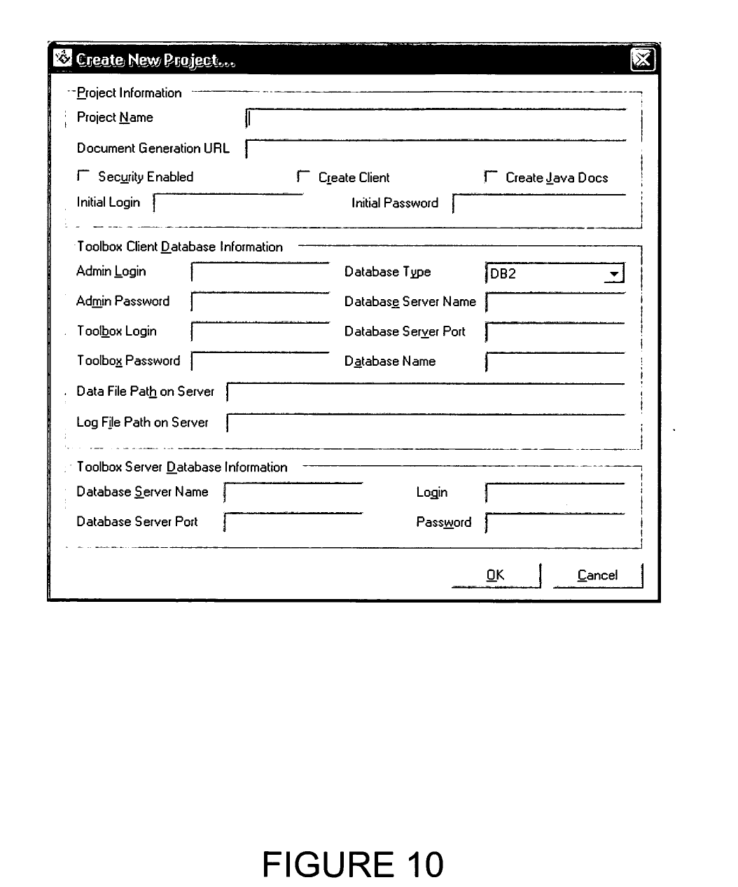

Application generation and deployment begins with the creation of a project, as accessed through the Tools Menu shown in FIG. 9. Initiating the application generation project can be accomplished by choosing Project Manager and then clicking Create, thereby presenting the project creation graphical user interface menu of FIG. 10. The Project Name becomes the name of the application project and, by default, is also used as the Database Name for the meta-model database for the application. This name will also be used as the name of the Java Enterprise ARchive (EAR) file for the generated application and will be part of the package name for all generated Java files. The Document Generation URL is the address used by business components to communicate with the Report Server 680. The Business Logic Builder Module 412 uses this address to access needed/requested document generation methods. Clicking Security Enabled determines that the project will be generated with security requirements, including login, password required, and user access rights. The Create Client option instructs the generation/deployment system to automatically create a sample web client each time application items are deployed as the application is being generated. Checking the Create Java Docs box will instruct the system to generate Java documentation automatically.

An additional option available during application project creation is “Create JUnit Tests.” Selecting this option instructs the system to create and deploy a JUnit test for each of the following application components: Entities, Search Procedures, ID Numbers, Business Components, List Services, and Security Services. JUnit tests will automatically be generated when any of these components are deployed, and these tests can then be initiated by the user from a menu command to test the deployed components (see FIG. 9). Instead of merely testing whether the finite function of the coded components work or not, exemplary embodiments are not so limited and create component JUnit test routines that test the life cycle functionality of the generated EJB's. Life cycle function testing provides for unit testing of the EJB's; that is, testing whether the EJB's perform as expected. The JUnit test routines herein further provide for testing functionality within the operating environment of the EJB's by testing whether the coded EJB's relate correctly and without error to each other. A test results report is generated and displayed to the developer, with any test failures being annotated with the reason(s) for failure.

The Initial Login and Password create a user ID and password for this project to secure the building of the application. The Admin Login and Password are the existing administrative ID and password for the particular database instance to which the user intends to connect. The Toolbox Login and Password are the user login keys for communication with the generation/deployment system Toolbox database 643. Database Type denotes the structure of the meta-model database, such as MSSQL. The Database Server (640) Name is the name of the server on which the meta-model database is to be created. The Database Server Port defaults to 1433 and can be changed as necessary. The Database Name is the system database instance and defaults to the project name. The Data File Path on Server and the Log File Path on Server refer to existing paths on the Database Server 640. If MSSQL has been selected/defaulted as a database type, the normal values are entered by default. These values can be changed to match different paths as needed.

The Toolbox Database Server (640) Name and Port entries define the connection from the Application Server 620 to the Database Server 640; normally they will be the same as specified for the connection used for the Toolbox modules 643. The Toolbox Server Database (643) Login and Password value are derived from the entries in the Toolbox Client Database Information fields but can be edited as needed, such as to accommodate firewall settings. Clicking OK results in the next menu page being presented to the user, displaying the information and options entered by the user and giving the user the opportunity to edit and/or accept the project definition data.

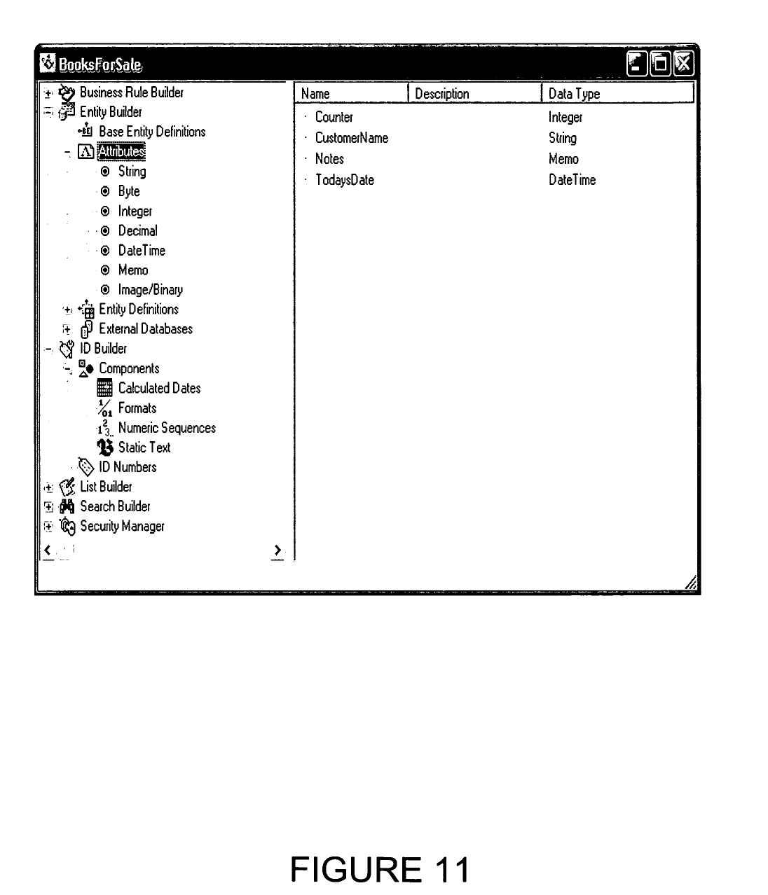

Having created the application project, the user is ready to begin using the toolbox modules shown in FIGS. 4, 5, and 6B to generate the desired enterprise application. FIG. 11 shows the toolbox menu upon selecting the entity builder module item from the toolbox menu of FIG. 5. The Entity Builder Module 402 uses a meta-data architecture in step 700 of FIG. 7 to define entities, attributes, relationships, and accesses to internal databases 118 and external databases 120, as is needed or desired. Entities are the principal data objects or concepts about which information is to be collected, manipulated, and/or stored for the application to be generated. Entities can represent specific concepts, such as persons, places, things, or events and can reside in databases and/or tables. Common examples include a customer, an employee, and a purchase order. Entities have, and include, attributes, which comprise the properties or characteristics for each entity defined by the user. For example, “last name” could be a data attribute of an employee entity.

Entities can also have relationships, which are the associations or interactions between and among two or more entities, such as a customer entity can be assigned a purchase order number, thereby having a purchase order relationship. Relationships are defined in terms of cardinality and direction. Each side of a relationship can involve one record or many records. Cardinality quantifies how many instances of one entity are related to a single instance of another entity. Possible cardinality are one-to-one (an employee is assigned one office cubicle only and a specific office cubicle is assigned to one employee only), one-to-many (a department can have many employees, but an employee can be a member of only one department), and many-to-many (a student can take many classes, and a class can have many students in it).

The directionality of a relationship describes how the relationship can be traversed, either bi-directionally or uni-directionally. A bi-directional relationship can be traversed beginning from either the “To Entity” or the “From Entity.” In other words, given one entity, the other entity can be found. A uni-directional relationship can only be traversed beginning from the “From Entity.” For example, if the user has a table of cars and a table of drivers and the user wants to search for those cars a particular driver drives but is not interested in which drivers drive a particular car, the user will select a uni-directional relationship between the cars and drivers. If the user wants to conduct both queries, a bi-directional relationship should be selected for the entities.

Each entity has one or more attributes and, optionally, relationships to other entities. As will be discussed in more detail below regarding the List Builder Module 406, entities can be associated together in lists by their common attributes and/or relationships. The Entity Builder Module 402 is responsible for capturing data requirements; generating database stored procedures and views; generating, compiling and deploying data objects in the Data Access Layer (DAL); and creating links to external databases 120. The Entity Builder Module 402 also allows the user to import and define relationships for tables in external databases 120. Accordingly, there is no need for the user to manually write, or even be familiar with, relational database code to save, delete, or retrieve entities. In this manner, the user can utilize a level of abstraction provided by the Entity Builder Module 402 and the List Builder Module 406 to define the characteristics of each class of entity and optionally, automatically import database tables 132 from external databases 120 defining the structure of the databases 120.

The user can define entities to describe groupings of data attributes. For example, an application could have a Judge entity defined. Each Judge can have a name, employee number, office number, hair color, date of birth, social security number, and/or several additional attributes. The entity can also be derived from another entity already existing in the system (i.e., a Circuit Court Judge may be defined as a Judge entity having additional attributes, such as a Circuit Court number). Each attribute for an entity is given a unique name and has a data type associated with it. Data types define the possible characteristics of the data that can be stored for a particular attribute. Examples of data types include integer, decimal, boolean, fixed-length text, unlimited text, and binary.

The Entity Builder Module 402 is further utilized to store data requirements in the database meta-tables 132 for an application project instance. It uses the stored data requirements to generate stored database procedures 126 and views 130 that depend upon the database architecture described below, which hides the actual database table structure used to store entity data values. In this manner, the Entity Builder Module 402, and not the user, determine and manage the structures and architecture of the databases and tables. The stored database procedures and views present a virtual interface to each database 120 that appears to provide a separate table 132 for each entity. Because of the distinction between the actual database table structure and the table structure implied by the interface, the actual database tables 132 are referred to as meta-tables.

Data to be utilized by the generated application, whether to be read or written, can reside in one or more databases, including internal databases 118 and external databases 120. In addition to defining new entities and/or attributes, the Entity Builder Module 402 provides the ability to link to these external databases 120 (i.e., databases other than the database 112 containing the meta-tables 132 for the project application and databases 118 managed by the system-generated application). When linking to an external database 120, the system can automatically import each database table structure with which to build an entity in the application and with which to navigate the external database 120 in the generated application, thereby saving the user the task of determining, specifying, and coding the database structure.

Alternately, some or all of the data for the application can reside on one or more internal databases 118 under a meta-model approach where newly-defined entities inherit one or more of the properties of a base entity, thereby simplifying the process of defining the entity and transferring the responsibility of managing the application data to the generation/deployment system. Exemplary embodiments permit applications to be built using either the external database model or the meta-data model approach, or a combination of both. Using the meta-module approach, the user can describe entities' attributes and relationships completely within the application generation system. Referring again to FIG. 11, the generation system contains pre-defined “Base Entities” constructs that can be utilized to create new and unique entities for the application. Additionally, the user can create his/her own base entities for use as templates in those instances where one or more entities have similar attributes and/or relationships.

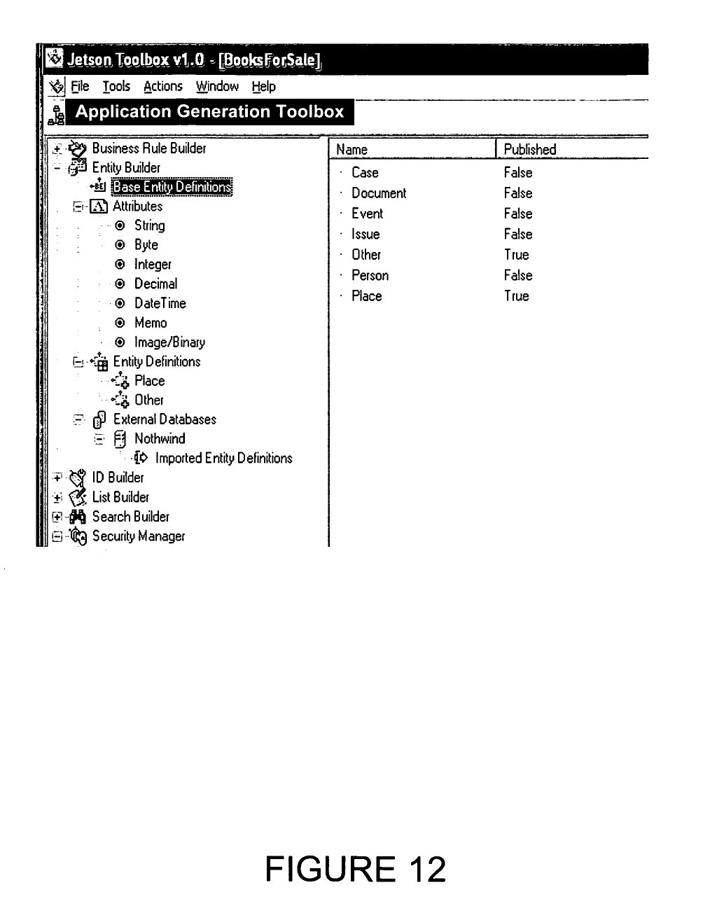

Once a new base entity has been created, the new base entity must be published to the generation system for the new base entity to be known, to appear as an entity definition in the Entity Builder menu (see FIG. 12), and to be available as a base entity. A new entity built from a base entity will inherit the characteristics of the base entity and can be customized with changed or new attributes and relationships as is required for the particular data type. Accordingly, there is no need for the user to redefine data characteristics that are common across databases and/or tables; and a combination of relational objects, relationships, and entity-attribute-value (EAV) database constructs can be utilized to define application data, including databases, including internal 118, external 120, and system 112 databases. An EAV database architecture is a form of modeling database data. In a traditional relational database, the attributes of an entity are fixed in a column-row structure. For example, if a Judge table has “first name,” “middle name,” and “last name” columns, all instances (rows) of a Judge entity will have these three attributes. If these three attributes constitute the only columns of the table, they are the only attributes any Judge instance will have. The entity-attribute-value database configuration creates a more flexible model by storing the attribute structure of an entity separately from the entity itself and further stores the data for specific instances separately from both. The EAV design is appropriate when the number of parameters or attributes that potentially might apply to an entity is significantly more than the number of attributes that actually apply to any individual entity or when the attributes of an entity may vary over time and in unanticipated ways. This design is particularly useful when it is possible that there may be additional attributes added or removed over the life of the system, as in the case with the Entity Builder Module 402, for example.

Once a base entity has been published, indexes can be added to the base entity for one or more fields of the entity. Indexes allow rows to be located more quickly and efficiently in queries. While the indexes do not appear to a user executing the generated application, they are given names to facilitate the indexing process and are assigned either ascending or descending attributes based on how the respective field is to be treated in application queries.

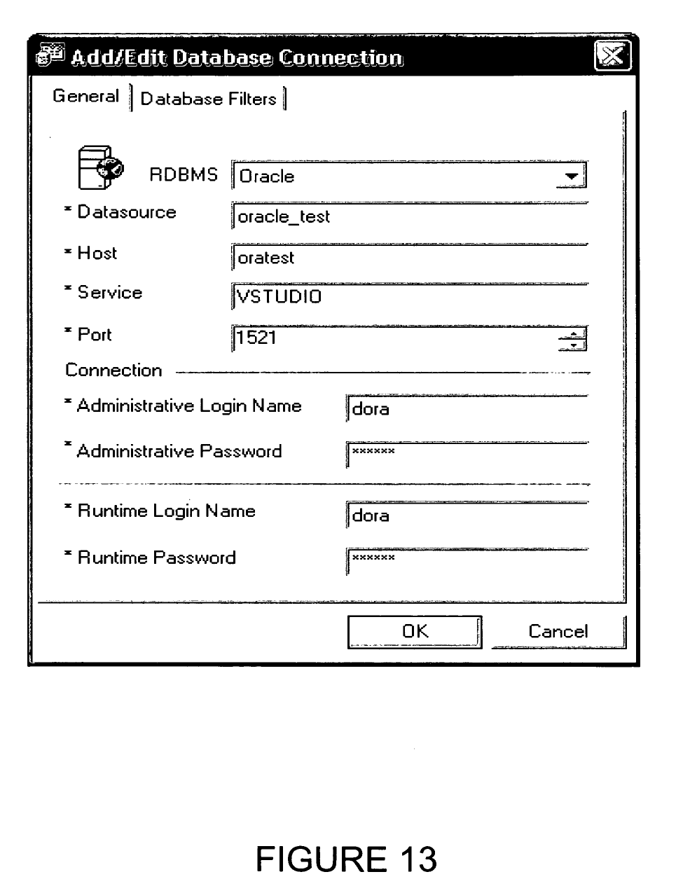

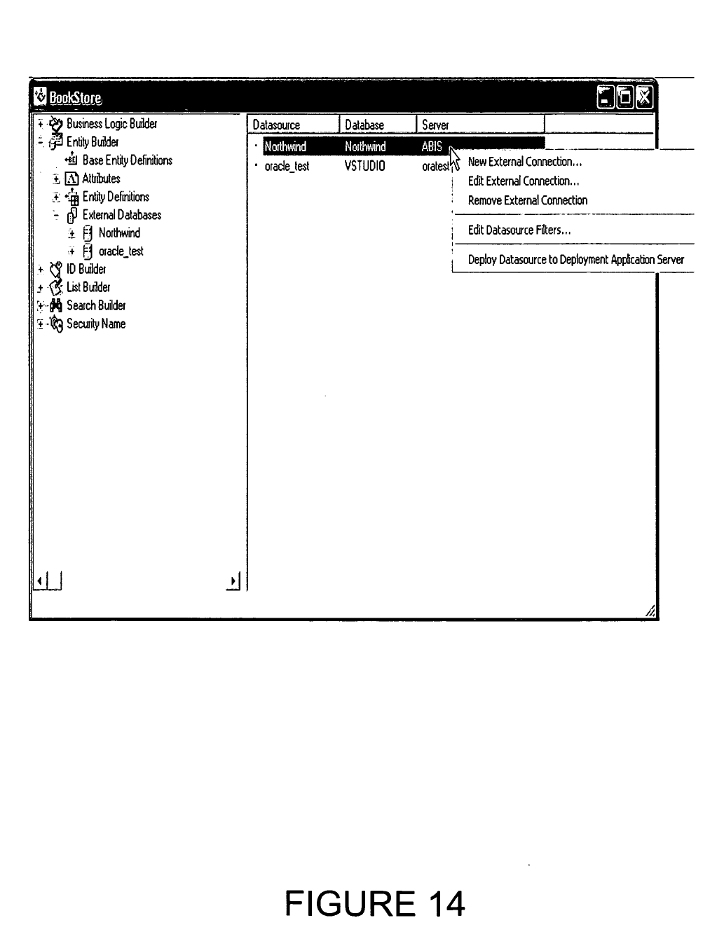

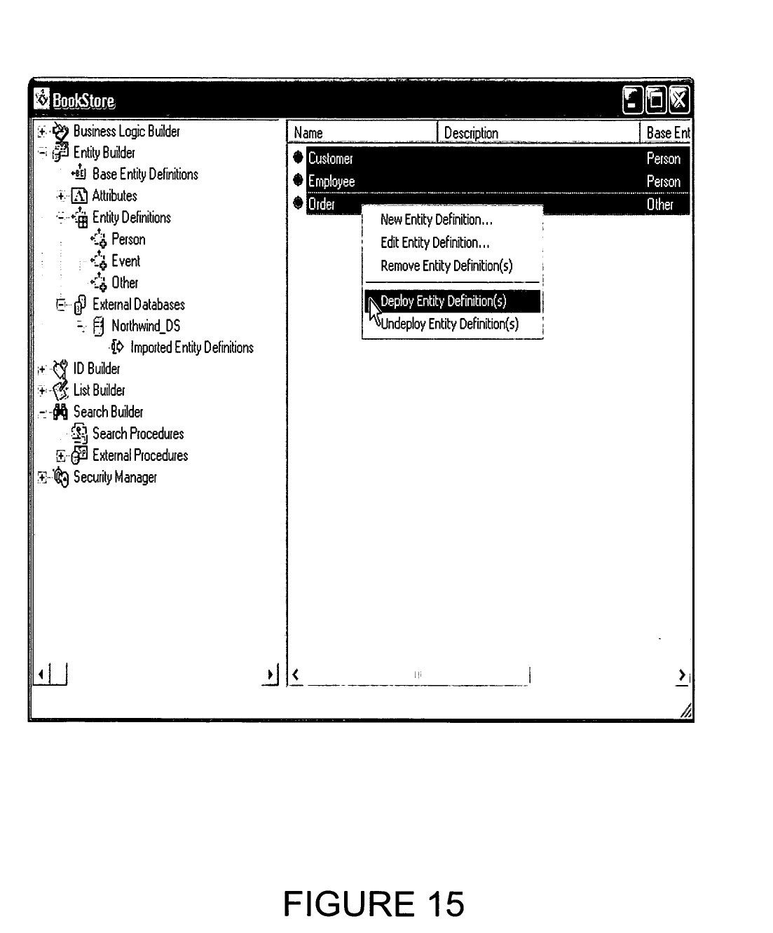

In those applications where application data resides on one or more external databases 120, the application developer accesses a database connection menu as shown in FIG. 13 for connecting to one or more external databases 120. Here the developer is prompted to enter the information needed for the application generation system to create the links to externally managed databases 120 during the generation process and during execution of the generated program. The RDBMS field is the type of database to be accessed, such as an SQL Server, Oracle, or DB2 file. The Datasource name is a user-specified name by which the database will be referenced. The Host through the Administrative Password information is provided by the user as is already established on the Database Server 640. Next, the Runtime Login Name and Password are provided as consistent with the database administrator. The Database Filters tab permits the user to specify which portions of this database are to be visible in the application user's window for this database. Once the database connection has been established, the database name (the Datasource entry) will appear as a subnode of the External Databases node of the Entity Builder menu (see FIG. 14). The application generation system can then access the external database 120 and import a database table for each desired entity in the database 120. Once the table has been imported, attributes and relationships can be modified according to the needs and logic of the desired enterprise application, and the resulting table is stored in the system database 112 as a database table 132 for use during application execution to define and access information from the corresponding database 120. Once an entity has been defined, the user instructs the system by means of the menu shown in FIG. 15 to deploy the entity definition onto the output database 112 for eventual use by the Business Logic Builder Module 412.

FIG. 15, which is representative of the graphical user interface by which a user can deploy the elements developed by the various toolbox modules, offers a color coded icon, or bullet, next to the entity name to indicate the status of the deployment of the entity definition. Under one embodiment, the icon is red to indicate that the entity is not deployed and is green to indicate that the entity has been deployed. A yellow icon can be used to indicate that an entity has been deployed and later changed as a visual indication to the user that the entity needs to be re-deployed. Other toolbox modules, including the Business Logic Builder Module 412 for deploying generated application code, similarly provide a color-coded scheme to graphically indicate the deployment status of items and components.

During actual application code generation by exemplary embodiments, the Entity Builder Module 402 uses the user-specified and default data requirements to generate a data access layer 208 of the application. The data access layer 208 is used to limit and enforce data access business logic for the project application. The system can generate Enterprise JavaBean (EJB) code that will properly execute on, for example and not limitation, an application server 620 conforming to the J2EE 1.3 specification (or later). The resulting Enterprise JavaBeans (EJB's) can use either bean-managed persistence (BMP) or container-managed persistence (CMP) as described in the J2EE specification to persist application data and relationships. The system compiles the generated code and deploys the compiled code to designated application servers. The J2EE specification requires that the Enterprise JavaBeans (EJB's) be accessible to external clients via Java Remote Method Invocation (RMI). EJB's generated by the Entity Builder Module 402 are designed to be accessible to application users via web services.

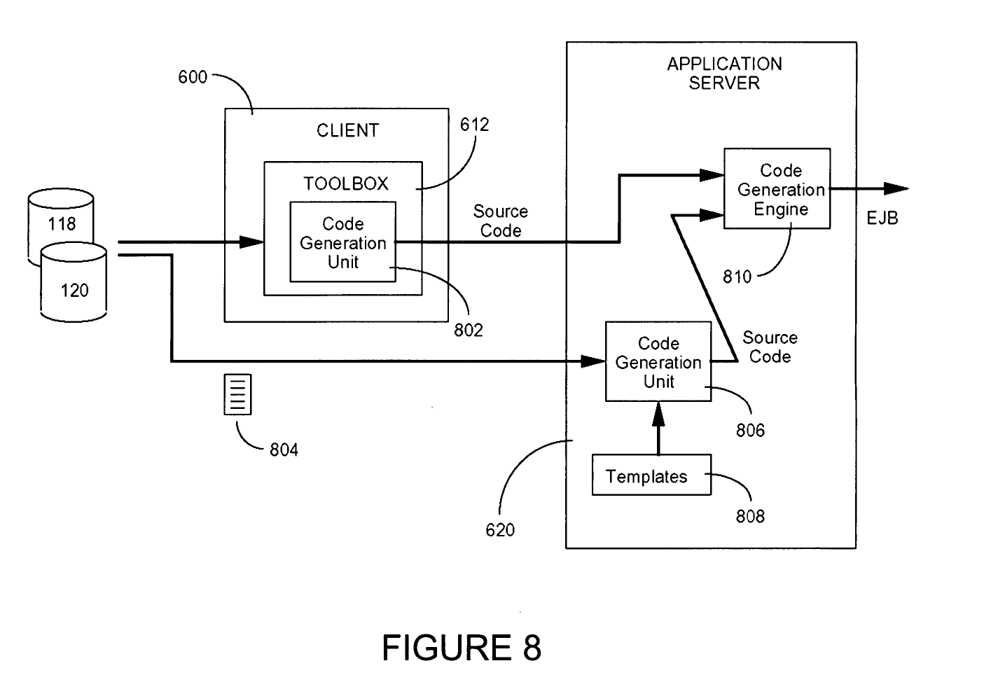

One example of the code-generation procedure is schematically illustrated in the block diagram of FIG. 8. In this embodiment, two processes are used to generate the code to be deployed. In one process, information about the objects and components to be generated, stored in one or more of the databases 118 and/or 120, is provided to the toolbox 612. One component of this toolbox is a code generation unit 802. This unit assembles the provided information into properly formatted and concatenated data strings that represent the information as Java source code documents. The Java source code documents are provided to the application server 620. An example of a suitable technology that can be employed to implement the code generation unit 802 is CodeDOM, a component of the Microsoft.NET Framework.

In the second process, an XML document 804 containing stored object and/or component information is provided to a template-based code generation unit 806 in the application server 620. The XML document 804 containing the information is created in the toolbox 612. The code generation unit 806 transforms the data in this document into source code, in accordance with templates 808 that are resident at the application server. In essence, the code generation unit 806 functions to replace tokens in the templates with data from the XML document, or with the results of processing that data according to rules in, or accessible to, the template, to produce the source code. An example of a suitable technology that can be employed to implement the code generation unit 806 is the Velocity Template Engine, an open-source program provided by The Apache Software Foundation. Although a direct link from the database(s) 118/120 to the application server 620 is depicted in FIG. 8 for purposes of explanation, in practice the entity information can be retrieved from the database(s) and provided to the server 620 via the toolbox 612.

The determination as to which code generation unit to employ for any particular component of the application can be based upon any number of factors. For instance, in one embodiment of the invention, the code generation unit 806 in the application server 620 can be used to generate the code for imported entities representing external databases 120, and perhaps other specific components, such as those pertaining to user security and lists, discussed below. All other code can be generated by the unit 802 in the client toolbox 612. However, either process can be employed to generate any component of the application code.

In an application which is deployable onto a J2EE-compliant server, each object and/or component can consist of multiple Java classes, each of which is represented in a separate Java source code file. For example, each Enterprise JavaBean (EJB) consists of at least 3 and as many as 6 or more such classes. It will be appreciated that the task of managing the large number of files that constitute an application can become overwhelming to the application developer. To reduce this task, therefore, the code generation units 802 and 806 can be configured to produce a single Java source code file, representing a single class, for each object and/or component. This approach also simplifies the deployment process, since the number of files to be deployed is greatly reduced. At code generation time, the source code files produced by each of the code generation units 802 and 806 are provided to another code generation engine 810. This code generation engine 810 utilizes tags and comments in each source code file to generate the other classes that are needed for the object and/or component. An example of a suitable technology that can be employed to implement the code generation engine 810 is XDoclet, an open-source program.

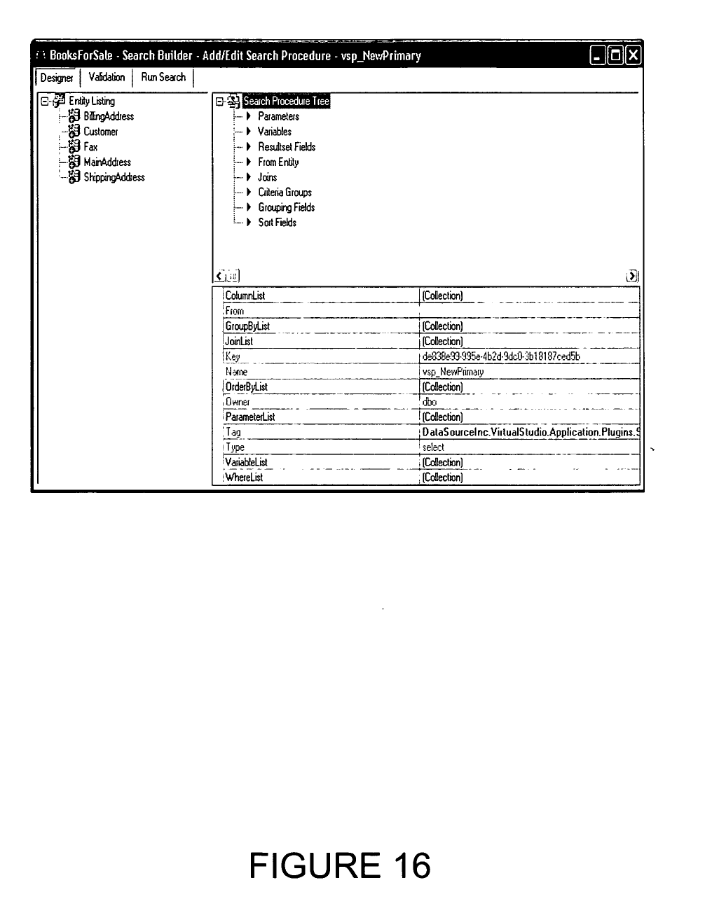

The Search Builder Module 404 allows the user to create custom database queries in step 702, whether as standalone queries, or as queries incorporated into the business logic/rules of the application, or as queries to be used to generate reports by the application. Each query is built using a graphical user interface designer, such as shown in FIG. 16 and allows the user to define various query elements, including:
Parameters—search parameters
Variables—predefined constants to be used as part of the search criteria
Columns—attributes making up the search results
From Entity—a base entity to be searched
Joins—entities related to the From Entity and to be joined with it in the search
Criteria Groups—criteria to filter the search results
Sorts—attributes used to sort the search results

The Search Builder Module 404 permits the user to define database queries to be included in the software application to return specific rows and columns of data from designated databases. By presenting several graphical user interface menus to the user, exemplary embodiments alleviate the need for an in-depth knowledge of system query language (SQL) and data structures and extensions which may be unique to each database. The user can easily construct a search using a visual designer presented by exemplary embodiments to guide the user through the search building process. Once the search has been built, the Search Builder Module 404 includes a facility for the user to test the search immediately. If the results are not satisfactory, the user can return to the search build menu, modify the search design, and retry the search. In this manner, modules of the software application can be easily and quickly tested during the application generation process. External databases can be imported into exemplary embodiments, and both the user and exemplary embodiments have full access to any stored procedures in each such database. Further, users can also write SQL code directly against external databases for inclusion in the software application being generated.

The search queries can be defined against both meta model databases and external databases. Since database structures in the form of database tables have been stored in the system database 132 and existing database search procedures have also been imported and stored in the system database 126, the user can also be presented with existing database structures and search procedures from which to select and, optionally, modify to define a desired database query. In either situation, the user need not have detailed knowledge of SQL commands nor particular database formats to define search queries consistent with a desired enterprise logic. In one embodiment of the invention, the coded queries are built by the code generation unit 802 in the toolbox 612. As an example, the unit 802 can generate one object for all of the searches to be performed on the internal database 118, and another object for each external database 120 to be searched.

While the user is building the search query by means of the Search Builder Module 404, an XML document is created in the background representing that query. The XML document is stored as an XML file in the application database 128 when the user finishes building or changing the query. This stored XML file is used to generate and deploy a stored procedure in the system database 126 and an associated data object in the Application Server 620. Search objects can also be created, following standard J2EE conventions and providing interfaces for discovery and execution that are used when building Business Components (BC) and Business Data Objects (BDO) as discussed below. These components and objects are implemented as Enterprise JavaBeans (EJB's) and data transfer objects (DTO's) in the generated code.

While a user is defining a new search procedure or is editing an existing query, the search procedure is locked for that user's access only. Once work on the query is complete, the user unlocks the procedure, and it is available for public use. The lock feature prevents simultaneous changing of records in a multi-user application generation and utilization environment. Once a user is finished defining or editing the application search procedures, all added and changed search procedures are deployed for use by the Business Logic Builder Module 412.

Many business enterprise applications utilize information and data elements that are inter-related or have one or more common attributes. Such data can be organized physically and/or virtually into lists of information and/or data objects, such as a customer list or a product list. For example, data can be associated into a list of states for use in addresses, a list of fonts to apply during text editing, or a list of data types to assign when creating attributes. Further, the lists of data can be used when populating forms and reports. Exemplary embodiments provide a feature of lookup lists to assist with accessing, manipulating, and viewing these lists. The List Builder Module 406 provides facilities for the user to define such lookup lists. With the List Builder Module 406, the user can create any number of lists, each with an unlimited number of list items, said lists being available for data population.

Lists can be of two types: master lists and presentation lists. A master list is used for grouping data that is subsequently used to define presentation lists. Each element of a master list is logically related to every other member of that list, as for example, a list of U.S. states and territories might be one master list in an application. A presentation list is a grouping of list items or lists from one or more master lists for presentation to a user or as input to subsequent data processing. A software application developer might create a presentation list of contiguous states, which would be a subset of a master list of U.S. states and territories. Another exemplary presentation list might include border states and bordering Canadian provinces, which would include a different subset of the same master list with additional list items taken from another master list, a list of Canadian provinces. Exemplary embodiments provide that changes made to lists or list items in a master list are automatically reflected in the presentation lists that use that master list.

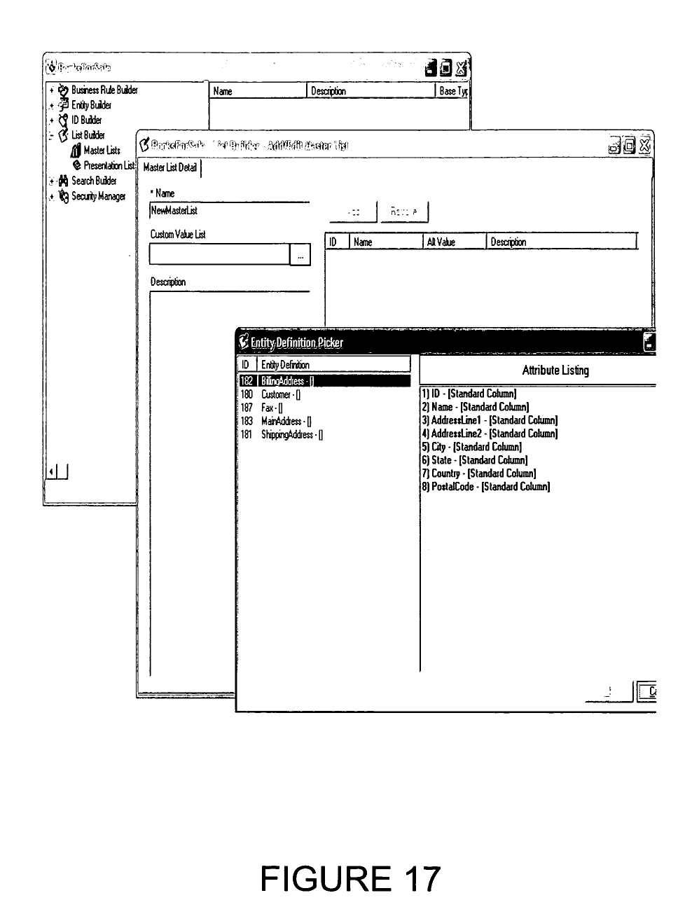

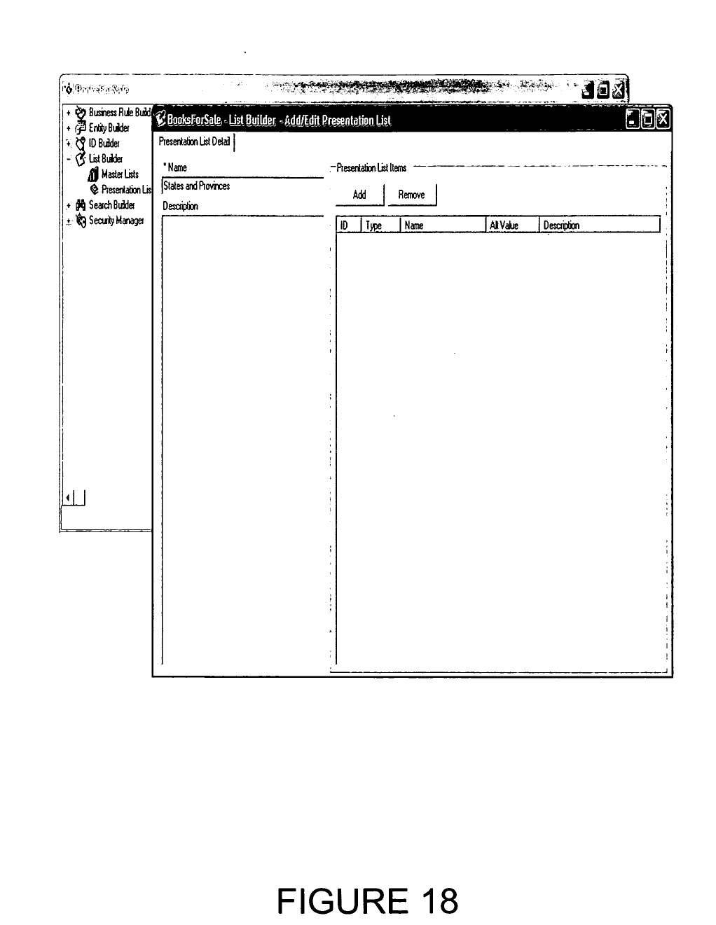

List definitions, as developed by the user through a graphical user interface, such as shown in FIG. 17, are stored directly in application system tables in the system database 112 and are used to generate and deploy List Services data objects. These data objects provide interfaces that are used by the Business Logic Builder 412 during business object creation. They also provide a generalized mechanism for the Business Logic Builder 412 to determine the available lists within the system. As discussed above, presentation lists are collections of data items from one or more master lists and/or one or more other presentation lists. As each presentation list is created by the generation system, with user input as shown in FIG. 18, the list is assigned an ID number by exemplary embodiments. This ID number can be used to call the list in the system-generated scripts of the Business Logic Builder Module 412.

Once the list definitions have been entered via an interface such as those shown in FIGS. 17 and 18, the code for automatically retrieving list data is generated via the code generation unit 806 in the application server 620. In practice, a single EJB can be generated for each application project to encapsulate the List Builder function. Since the production of lists is based upon data stored in a database, the generated EJB includes the ability to access the databases 118/120.

The Identification Builder Module 408 permits the generated application to accommodate any ID format, such as needed for data identification. Business and enterprise applications often utilize one or more identification (ID) number schemes for quickly and easily categorizing, identifying, and finding specific records and data items within a large collection. When transitioning to an automated system, such as converting an existing local system to a networked application to be made available as a web service, there can be a mismatch between the identification scheme already in place and the identification scheme developed for the automated system. The Identification Builder Module 408 defines creational processes for item identification numbers by allowing the user to create a formatted record identification string that conforms to existing business logic/rules for creating and assigning identifier values to any entity. The resulting identification number can be used, for example, as an account number, a case number, a purchase order number, or any other form of identification. In this manner, the logic of the generated application is compatible with the existing logic and data of the enterprise.

The identification string can be comprised of one or more elements or components, including static text, calculated dates, numeric sequences, and formats, for example. An example will show some of the flexibility that can be achieved by the Identification Builder Module 408 for creating ID strings. The generated string DSI-020766-028.206 can be created from the following components:

| Element | Element Type |
|---|---|
| DSI | Static Text |
| — | Static Text |
| 020766 | Calculated Date with date format applied (MMDDYY) |
| — | Static Text |
| 028.206 | Numeric Sequence with numeric format applied |
| | (000.000) |

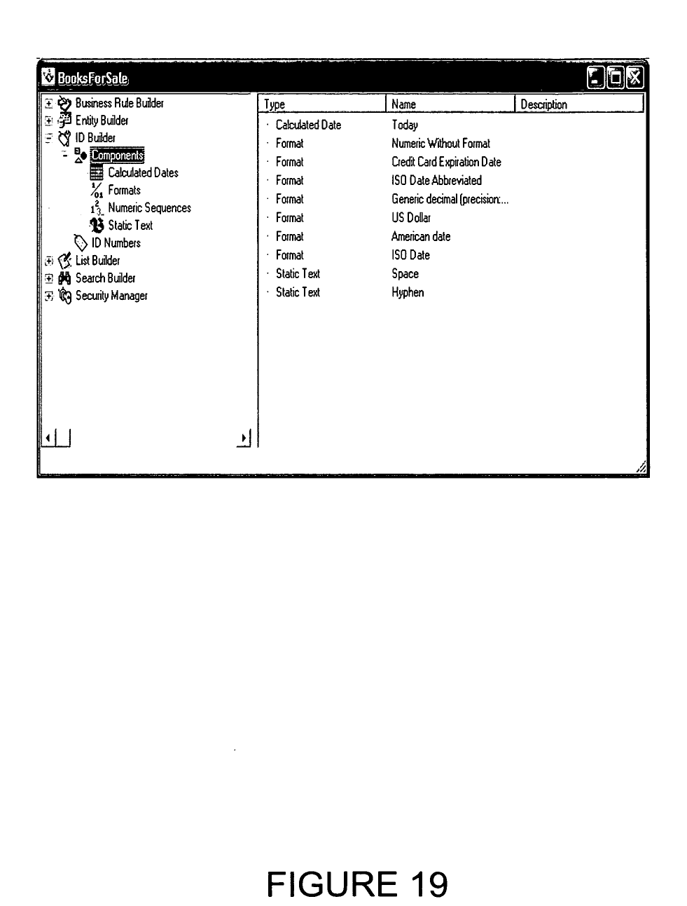

By defining multiple element and ID rules through a versatile graphical user interface such as shown in FIG. 19, a user can recreate virtually any ID scheme in current use. Further, ID formats can be defined to output a date or numeric sequence in any desired form. Numeric sequences can also be defined to restart or reset after a particular time period, value, or date. Further, components can be defined to have one or more fields automatically repeat. Formats are masks that can be applied to calculated dates or numeric sequences to extract only the desired portion of the date or number and to define the order of the date parts. These rules can also be used to generate data transfer objects accessible within the Business Logic Builder Module 412. Upon deployment of each ID number, it becomes available for use by the Business Logic Builder Module 412.

Once the appropriate data has been entered via the interface of FIG. 19, IDs are automatically built via database-stored procedures 126. An EJB that can access those procedures is generated via the code generation unit 802 in the toolbox 612. Like the List Builder, a single EJB can be generated for each application project to encapsulate this function.

The Security Manager Module 410 is used to define application users, roles, and groups in step 704 and is a tool that is intended for use in both the application generation and the application execution environments. This module manages all aspects of security within the generation and the application production environments, including system users, groups, roles, and permissions. The security settings allow the system administrator to determine at a very granular level which data and system features are accessible to any user. In one embodiment, permissions are grouped together as roles, and the roles are then assigned to users for granting individual users various permissions, or authority to access one or more features. By combining users into groups and assigning them to one or more roles, the administrator can manage very large groups of users easily. Additionally, permissions assigned by roles can be individually overridden, allowing complete control over each user's access. In one embodiment, application access rights are defined in terms of permissions to call methods on the objects generated by the system, thereby controlling user access by system or application feature.

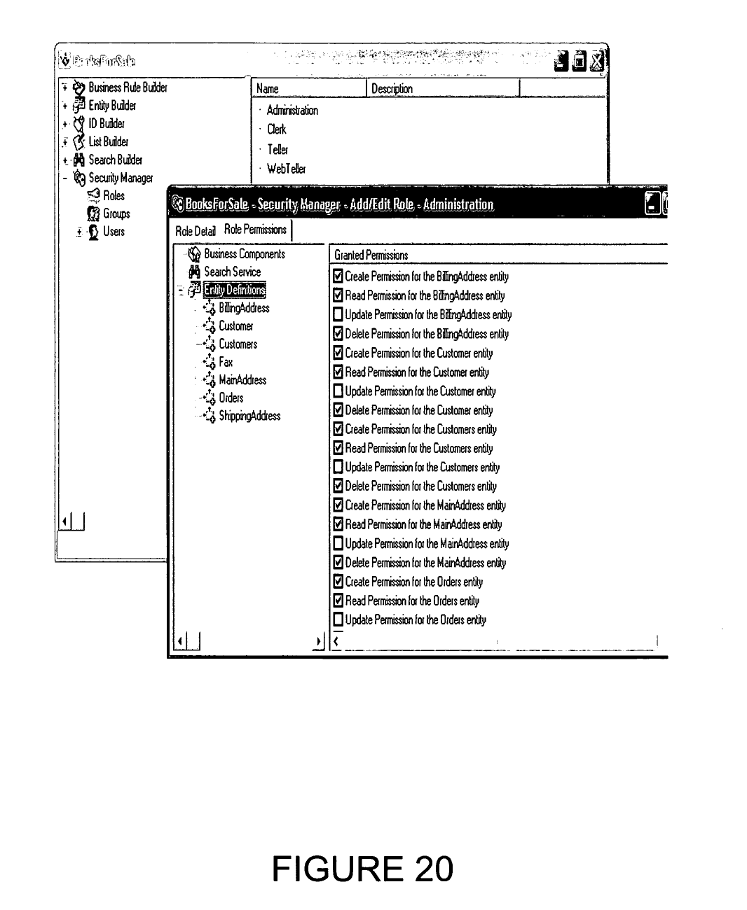

In another embodiment, roles are defined as sets of specific permissions that allow application users to work with defined entities. Each entity is created with four possible levels of permission, namely create, read, update (write), and/or delete. When a particular role is defined for an entity, each of the four permissions are either granted or denied for a user assigned that particular role as regards the entity. FIG. 20 shows an exemplary graphical user interface whereby an application administrator can establish the roles for the users of an application. An application user is any individual identity that has been granted access to the application. A user can have more than one role associated with that identity, and the user is entitled to all permissions included in those associated roles.

The system uses positive grant access permissions to allow access to resources. A resource not specifically granted to a user is denied to that user. The Security Manager Module 410 provides an interface which allows permissions to be granted or revoked individually, so that each user's access can be narrowly tailored. For example, a Judge can be granted permission to enter rulings within a system, but can be limited to entering rulings for the Judge's own court only.

Security permissions can be modified without stopping or recompiling the generated application. In this embodiment, assigned roles applicable to users are maintained in a system database 112 and are not within the application itself. Further, the logic that maps the executable methods or features to roles is not retained within the application. Such security information is defined in a system database 112 and is cached within the application at the start of the application and is cleared upon a database change within the application or at the termination of the execution of the application. Therefore, roles and permissions can be changed and are automatically made effective upon the next start of the application or the access of the security information portion of the system database 112. Accordingly, any changes or additions to roles and permissions are automatically deployed when saved to the system database 112.

The Business Logic Builder Module 412 is used to define the business logic, or rules, in step 706 for directing the running or processing of the generated application. In particular, this module provides for the creation, maintenance, and deployment of business objects and client-side scripts that perform the logic of the user's enterprise application. Business objects and client-side scripts are defined using a custom, XML-based scripting language. Business objects represent the business logic of an application. The Business Logic Builder Module 412 provides a framework for easily constructing these objects, ensuring that business objects generated and deployed adhere to the requirements of the user's intended enterprise application. It is through the Business Logic Builder Module 412 that the enterprise business rules, or logic, are translated into the software logic of the generated enterprise application. Through the performance of the Business Logic Builder Module 412, a level of abstraction is provided to the user so the resulting application can be server independent in that the resulting code need not be modified to be migrated from one server to another. The user interface presented by the Business Logic Builder Module 412 simplifies the creation of these objects by providing language tools, functions, and access to the other objects created and deployed by exemplary application generation modules (402-410), such as entities, lists, ID's and the like, including business objects that have already been deployed.

Business objects can be divided into two types. First, Business Data Objects (BDO) represent entity components derived from one or more data transfer objects (DTO's) created using the Entity Builder Module 402 and can be viewed as containers or buckets of data to be moved, manipulated, transferred, and the like. Business Data Objects can also expose custom attributes related to the objects they encapsulate. Their purpose is to join various data transfer objects (DTO's) into a logical grouping. For example, a Judge Business Data Object might include data from several related entities:
Judge
Work Address
Home Address
Work Phone Number
Home Phone Number

The second type of business object, Business Components (BC), comprises the actual business logic for an application, encompassing all the methods intended for client interaction. These methods include those objects necessary for standard create, read, update, and delete (CRUD) operations on Entity Builder entities and Business Data Objects. Business Component objects can also include Boolean logic, branches, and conditions. Typically, an enterprise application is comprised of one or more business components, each of which can be comprised of one or more methods. For example, a Judge's Business Component might include the following methods:
Create Judge (creates and returns a Judge business data object)
Save Judge (saves all Entity Builder data transfer objects within a Judge business data object)
Transfer Judge (contains the logic to update a Judge business data object, moving a Judge from one court to another)

Business Components can be implemented as generated Enterprise JavaBeans (EJB's) within a J2EE v1.3 (or later) application server 620. In one exemplary embodiment, the Business Logic Builder Module 412 can generate code to make methods of these EJB's accessible via web services 610 using Simple Object Access Protocol (SOAP).

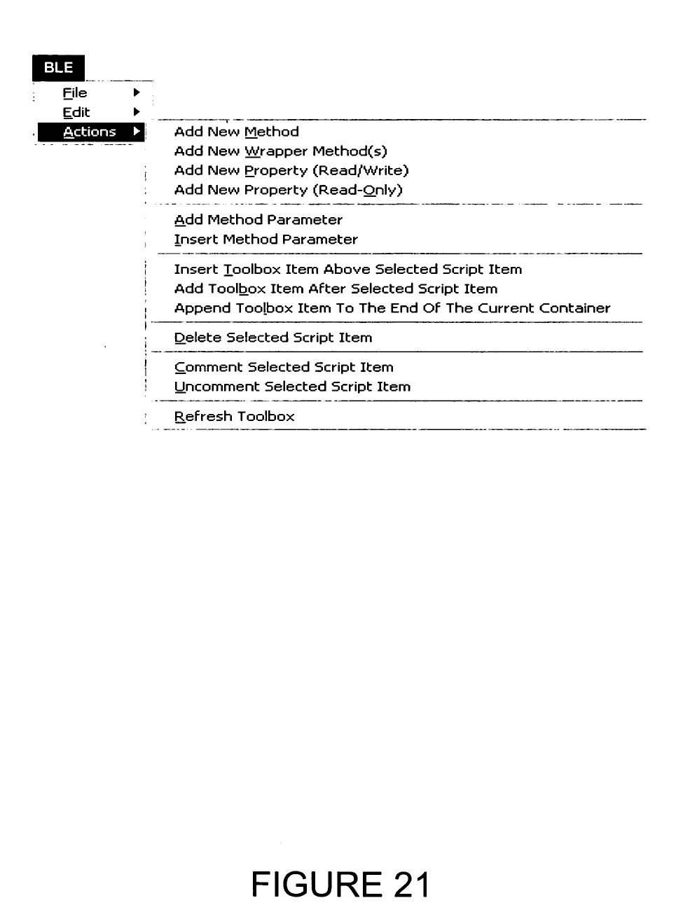

Creation and editing of business data objects and business components are performed within the Business Logic Editor (BLE) of the Business Logic Builder Module 412. For example, via the Code Generation Unit 802 within the client Toolbox 612, the Business Logic Editor presents to the user the script of the business data object or the business component along with a toolbox of action components that can be used within scripts as well as a properties grid for specifying the properties of a tool, method, or functionality added to the script. In this manner, the generation system creates the actual business logic code of the application at step 708 while the user stays at the logical level and need not be concerned nor involved in the specific conditional clauses or the coded program instructions to effect the business logic of the enterprise application into a coded and compiled application. The graphical user interface through which the available Editor tools and corresponding actions are presented for selection by the user is shown in FIG. 21.

The Business Logic Editor also has the flexibility of allowing the user/developer to create/import and install client-side, or user-drafted, scripts. These client-side scripts can, for example and not limitation, control application workflow, respond to client-side events, and determine which screens are displayed to the application user. The Business Logic Editor can store all such scripts as XML documents in the system database 128. Like forms, business objects and client scripts are assigned a version number; and all share locking mechanisms that allow multiple developers to work on an application without conflict.

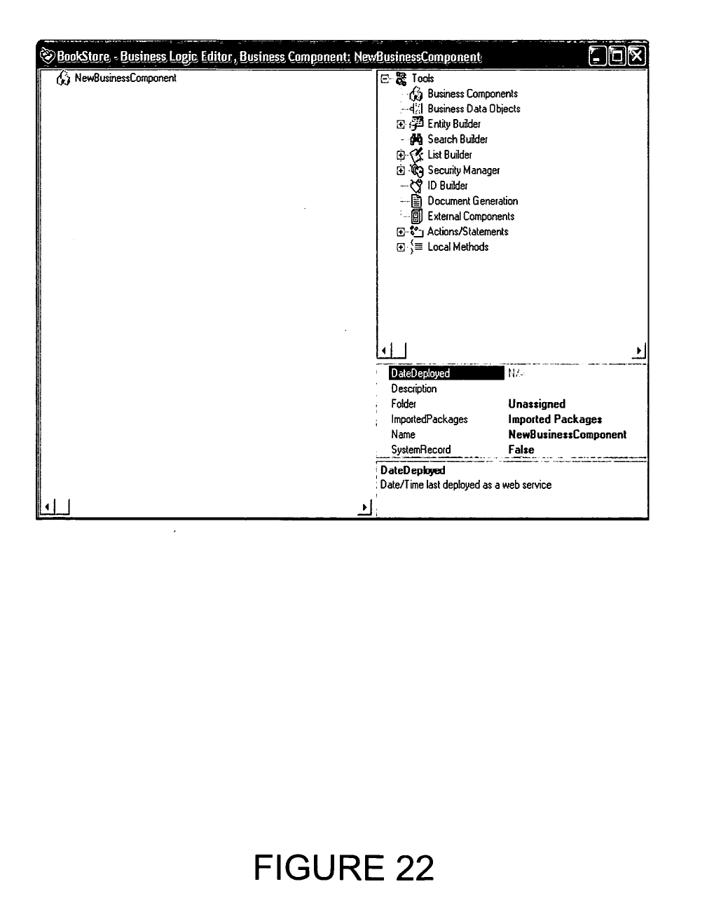

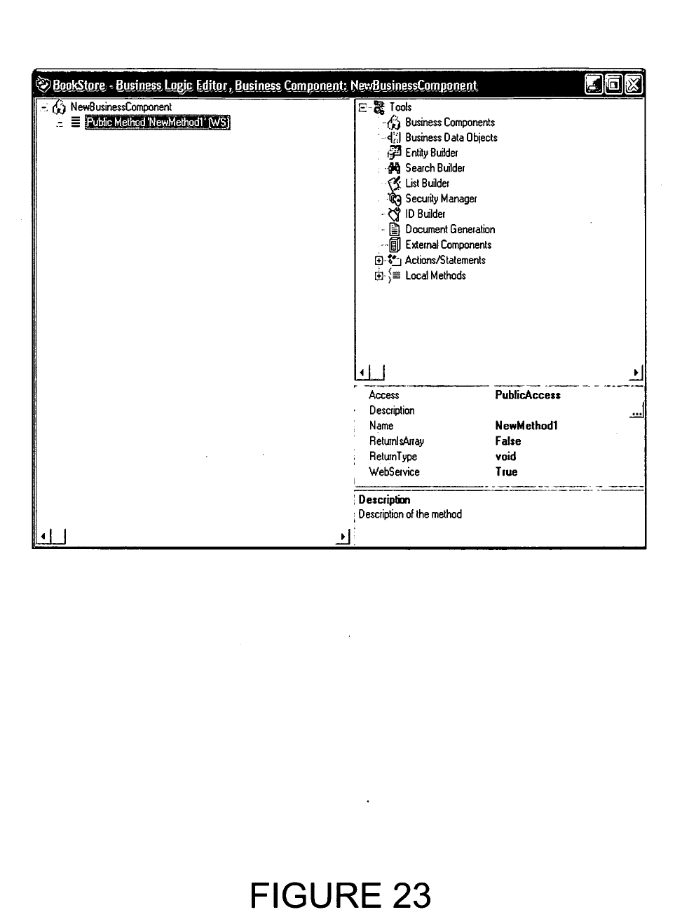

Referring now to FIG. 22, generation of the actual enterprise application begins with the building of the business components and the methods nested within each business component of the application. Right-clicking on the Business Components of the Tools on the right side of the menu of FIG. 22 and selecting New Business Component opens the Business Logic Editor. The generation system immediately and automatically gathers information on all deployed entities, search procedures, ID numbers, business components, and business data objects, as well as list and security definitions, and populates the Tools list with them. The business component's name and description is next edited in the menu, with an exemplary result showing in FIG. 23.

The methods of each business component can be constructed in two ways. First, the method can be built manually by adding a new (empty) method and adding statements and commands to build the logic and instructions of the method. Second, the method can be built automatically by selecting an item from the Tools list and creating a Wrapper Method for that item. Under the first option, the Add New Method button (see FIG. 21) is clicked to begin construction of the method. The Access field is set to be either Public or Private (see FIG. 23). Public access means the method will be visible to the user. If set to Private, this method will be accessible only by other business components. The Name and Description fields are then edited to define the method. The value of the ReturnsIsArray is then set, meaning that this method returns an array of objects or values (true) or returns a single object or value (false). Next, the ReturnType is defined and can be set to any data type, including Java data types, or else set to Void. Whether this method will be published as a Web Service is then specified. Next, the user can start constructing the script of the method by adding new commands and/or parameters or adding items from the Tools list. Multiple methods can be built for the business component in this manner until the full logic of the business component is complete.

Opening each node in the Tools list will reveal, and provide access to, the data objects and methods that have been developed and deployed during the application generation process so far. The Tools list includes a node for each of the five toolbox modules (402-410) discussed above, in addition to a node each for the Business Components and the Business Data Objects. Further, the Tools list includes four nodes not created by the application generation toolbox and not yet discussed. The Document Generation node includes a report builder for developing script statements for handling output reports for the generated application. External Components are logic modules in the form of, for example and not limitation, Enterprise JavaBeans (EJB's), functional code, and web services from external sources, including Java libraries. These external sources and libraries such as legacy systems and open source products, can be imported and then can be incorporated into scripts in the same manner as the Toolbox items to generate the functionality of the enterprise application. In this manner, existing third-party business logic can be utilized rather than having to recreate it.

Actions/Statements are logic statements for use in building method scripts and can be a convenient technique for including common functionality to business components. For example and not limitation, entries in this node can provide for calculations, conversions, date operations, exception handling, file operations, flow control, and memory actions. These statements and blocks of statements can include Java code snippets for inserting hand-written Java code into the enterprise application. When the developer is ready to add the Java snippet code, the system automatically generates and displays on the developer's computer 104 the Java code corresponding to the business component so far developed, both before and after the location in the business logic where the developer wishes to insert his/her Java snippet. The generated code is for display only, to inform the developer of the context in which he/she will be writing Java code so the Java snippet can be written with full knowledge of the environment in which it will run. Comments are displayed on either side of the generated code to serve as markers to the developer for the beginning and ending of the code snippet to be added. The Java code itself can be inserted by the developer using the default text editor, or a text editor of the developer's preference can be opened for assisting with the creating and insertion of the Java code. Upon code generation, the Java snippet code is treated as a string literal that is placed in the position indicated for it in the business component. The concatenated result of the generated code and the inserted literal Java snippet code is output from the generation process for ultimate deployment. Local Methods are business components that have been previously defined in the generation process that can also be called as methods in any other business component.

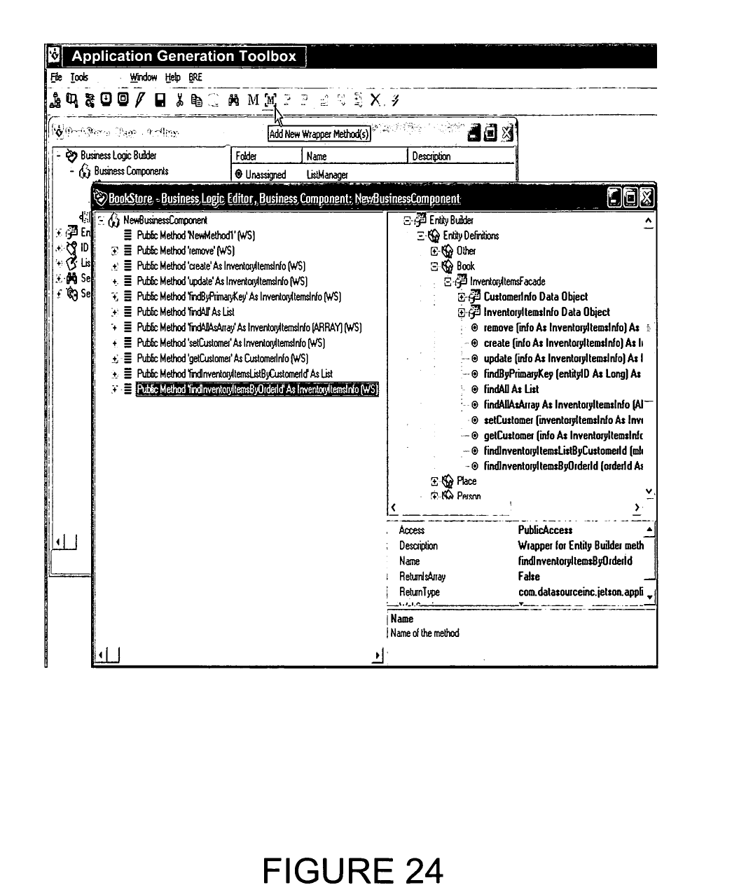

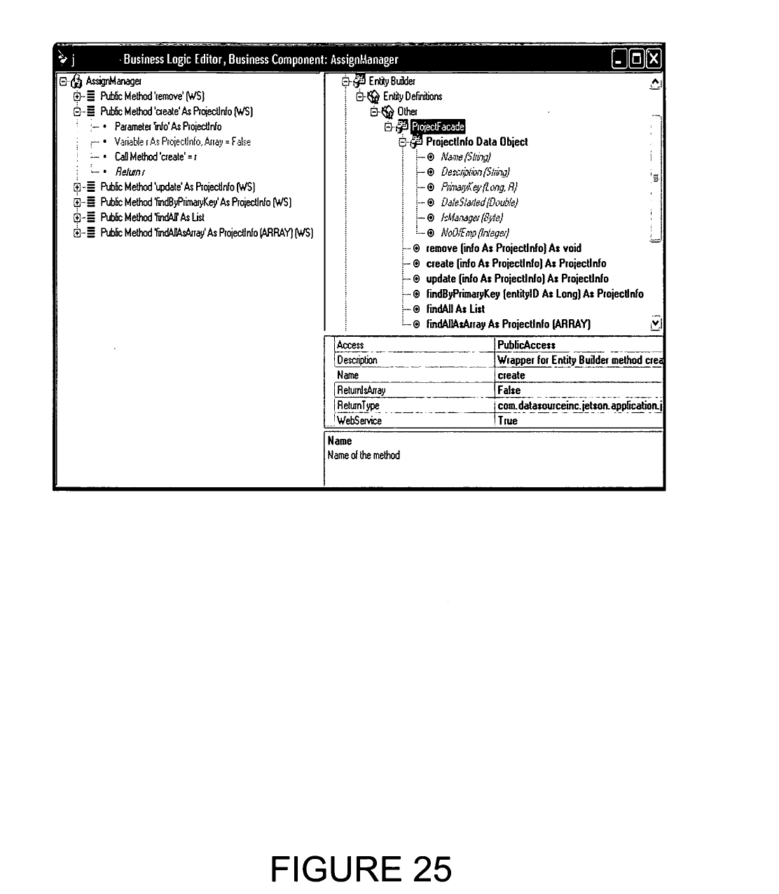

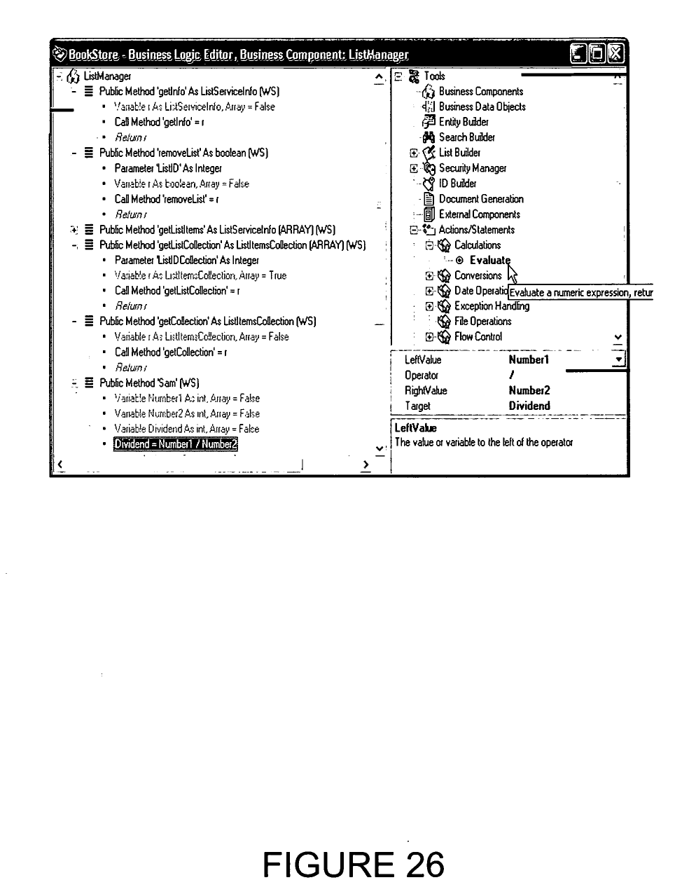

Referring now to FIG. 24, there is shown a menu for automatically generating new methods within a business component by use of the auto-generate wrapper method of exemplary embodiments. This option for building a new method is initiated by selecting a desired Tools item, including Entity Builder, Search Builder, List Builder, Security Manager, ID Builder, Document Generation, or External Components, and clicking the Add New Wrapper Method(s) button. In response to this single click or tool selection, the application generation system will automatically import and/or add one wrapper method to the business component for every method in the selected item (see FIG. 25). Each wrapper method contains the statements required to make the method function properly, and default values are assigned for each element in every statement. Additional statements can be added to the provided script as needed or desired, and default values can be changed as needed. Additional methods are added until the functionality of the business component is complete. A logical view of the application after the methods have been built and/or generated is shown in FIG. 26, where a partial view of the business component tree of the logic of the application is shown on the left side of the display, and the user's tools list is shown on the right side.

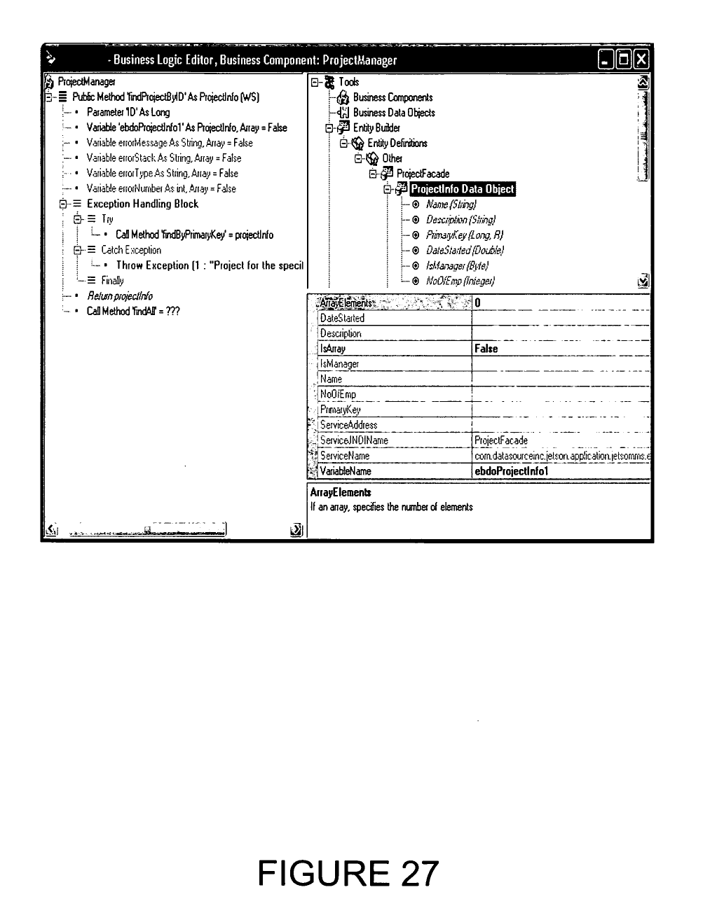

Referring now to FIG. 27, the Tools list shows the data types contained in each data object. Only the data object as a whole can be added to the script being generated. To use a data object in the script, the desired Data Object subnode of a Toolbox Module of the Tools list is selected; and the user chooses one of Add, Insert, or Append Toolbox Item commands. The data object is then placed in the script as a variable. The user can then define the Variable Name (the default name can be changed), the IsArray field (true or false), and the Array Elements field (the number of elements in the array if IsArray is true).

An additional feature of the Business Logic Module 412 is the creation of pseudo code on demand. The user can define various business rules with which to guide the generated application; and, upon the press of a button or clicking on this feature on his/her computer 104, the generation system will output a listing of pseudo code describing the function, logic, and/or system defined by the user. In one exemplary embodiment, the pseudo code is generated in compliance with the Java Remote Method Implementation (RMI) protocol.

Exemplary embodiments provide a mechanism for designing and deploying graphical user interface screens for presenting information, menus, requests for information, and the like to the application user at run time. A form editor within the Business Logic Builder Module 412 provides a graphical user interface for creating application screens to be used in the generated application. The form editor allows the application developer to position screen components on the form and to set their properties. The form editor allows the developer to break screens into smaller constituent parts and reuse these parts, or sub-screens, in the final application. For example, a developer might create a simple address sub-screen. This address sub-screen could then be placed on any other screen needing to capture or display address data, such as with the Local Methods feature described above. Through the judicious use of sub-screens, the developer is able to significantly reduce the amount of work necessary to produce the project application.

Additionally, the form editor allows the developer to lock a form while it is being edited to prevent other users from simultaneously modifying the form. This mechanism helps ensure that multiple developers are not overwriting each other's work. The created/edited form can then be saved to the database 112 in an XML format. Forms produced by the form editor are used by a rendering engine at runtime to produce the screens that are presented to and viewed by the application user. When a form is saved to the database 112, it is assigned a version number, which is incremented each time the form is modified. By comparing version numbers at runtime, the system can quickly determine whether or not the user's computer has the latest client version in their local cache. If the latest version is not in use, it is automatically and seamlessly transmitted to the client user for use.

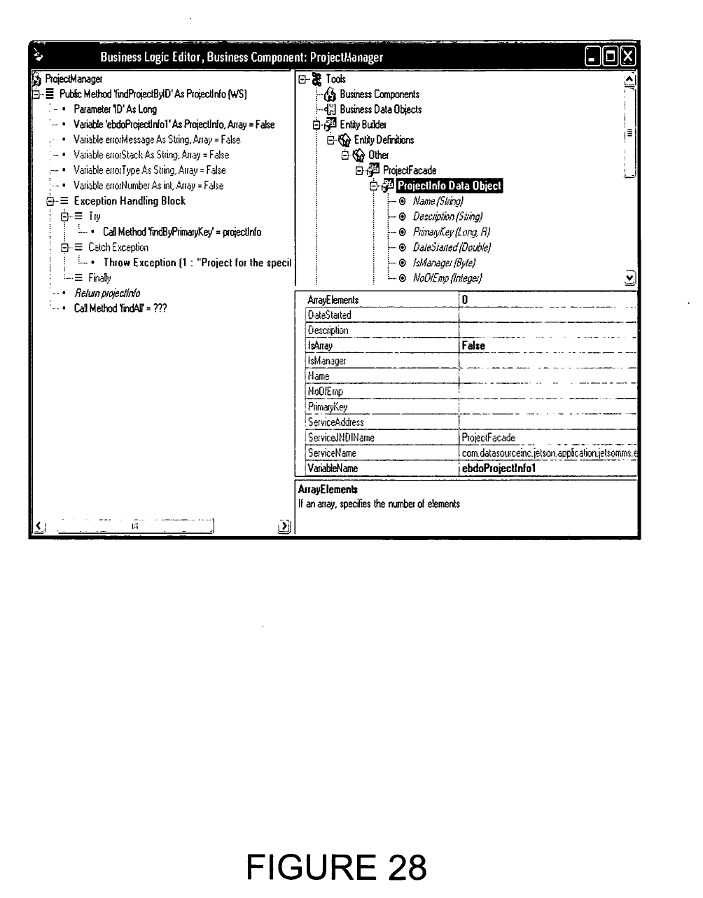

As discussed above regarding the Document Generation node/feature, exemplary embodiments can utilize one or more document/report generation engines optionally accessible through the Report Server 680, depending on the needs and requirements of the enterprise application to be generated and operated. For example, a current industry standard reporting engine, Crystal Reports, is accessible as a plug-in to the application generation Toolbox for allowing the developer to define reports and to identify associated data objects within the system for inclusion in application-generated documents and reports. FIG. 28 shows a report builder menu available to the application generator for developing reports to be generated, printed, and/or exported by the application. The report definitions created by this feature are stored in the database112 and are used by the document generation service(s) to determine what report files and data objects are needed to run a specific report. Each report can consist of one or more Crystal Reports .rpt files and associated data definition files.

Upon completion of the business component and business data object construction process, or alternately upon partial completion of the application generation process, all generated components and data objects are deployed in step 710 to be made available to non-local Business Components and application users. Accordingly, portions of, or a part of an entire software application, including specific modules, can be generated and deployed. A business component and/or a business data object can be undeployed to remove it from the available enterprise application environment. A color-coded icon or button next to each component and object displayed to the user indicates the deployment status, with, for example, green indicating a deployed status and red indicating an undeployed status. Yellow can indicate that the business component/object has been deployed and then changed, thereby visually indicating that the component/object needs to be re-deployed. The Business Logic Builder Module 412 deploys and undeploys the generated software code and objects, including Session Enterprise JavaBeans (EJB's) and methods (including remove, create, update, find by primary key, find all), to the target Application Server 620 environment for subsequent access by the application users/clients. Exemplary embodiments deploy the following application components for subsequent access and/or usage by the enterprise application:
Entities (both internal (meta-model) and external)
Search Procedures (primary search procedures, imported search procedures, and custom queries)
ID Numbers
Business Data Objects
Business Components

Lists and security services can be deployed to the one or more targeted Application Servers 620 as soon as any one of the above components are deployed. Exemplary embodiments are application server platform-independent in that the enterprise application can be generated to be compatible with any number of operating system protocols, computer platforms, and networks. Exemplary embodiments provide for auto-deployment from one operating system platform to another.

Referring again to FIG. 1, the output database 112 uses a hybrid entity-attribute-value (EAV) design for storing application data in a format optimized to balance both performance and flexibility. This format allows new entities and attributes to be added to an existing application without breaking the application or disturbing existing data. Additionally, entities or attributes can be “deleted” even while preserving the data that existed in that entity or attribute. The output database 112 is comprised of multiple layers. An EAV physical data model is implemented in Tables 132, and an entity-based logical model is layered atop this using Views 130 and Stored Procedures 126. This entity-based layer converts output from the table level to an entity view, and converts entity-based input to a table representation for storage.

The Database Tables 132 store three separate types of data: application component design data, component instance data, and security data. These three sets of tables provide all of the functionality required to model and store data for any logical entity-relationship data model. The component design tables are used by the client Toolbox and are never accessed directly by any developer or runtime application. They are used are used to store the definitions of any objects created by the development tools. They do not contain any component instance data. These tables contain the component structure, but no instance data records.

The component instance tables store the actual business data entered or generated by the running application. For example, if the developer creates a Judge entity using the Entity Builder Module 402, the definition of that entity is stored in the component design tables, but specific records of Judge data are stored in the component instance tables. The instance data records can only be interpreted in terms of the structure stored in the component design tables.

The security data tables store all of the security information required by exemplary embodiments during actual application operation. This security information includes user, group, role, and permission data. This data is stored by the Security Manager Module 410 plug-in and is utilized by the security services framework to permit or deny user access to each business object, data object, entity, and entity record in the system.

The information stored in the Views database 130 is used to translate the physical model represented by the tables into a logical model which is used by the rest of the Toolbox suite and by the generated application. The database Views 130 presents a logical model of the application to the rest of the system. Access to the Views information is also available through the database Stored Procedures 126, which contains logic to process Views information before returning the results to the user. The generated code uses both generated Views and generated Stored Procedures to produce a logical entity view of the application at runtime. This ensures that data access to the entity record level is properly managed.

There are several types of views, including application views and entity views. An application view provides a logical view of the application generation system tables including the lists created by the List Builder Module 406, while entity views provide a logical view of the entities defined in the Entity Builder Module 402. Application views are predefined, while entity views are automatically generated by the Entity Builder Module 402. Whenever a user changes an entity, the Entity Builder Module 402 re-generates and re-deploys an updated version of the view that represents the current logical entity definition. Note that the security tables do not have a corresponding set of views because the base security table's logical and physical data models are the same.

The Stored Procedures 126 provide granular CRUD (create, read, update, and delete) access to the underlying tables and views stored in databases 132 and 130. These stored procedures are called directly by the generated entity, search, ID, list, and business component Enterprise JavaBeans (EJB's). They are also called from the application development tools. There are several types of stored procedures, including application procedures, business procedures, entity procedures and search procedures.

Application procedures are the primary procedures used by the application development tools for accessing and maintaining application views and security tables. Only user accounts with development tool access permissions have permission to call these stored procedures. Business procedures are a set of runtime helpers that provide access to ID and list functions. These procedures are called by ID and list session Enterprise JavaBeans (EJB's).

Entity procedures are the procedures used by meta-model entities to store and retrieve application data. These procedures are automatically generated by the Entity Builder Module 402 following creation or update of an entity. These procedures are not part of the application generation framework and are specific to each application generated by exemplary embodiments. Search procedures represent stored procedures generated and maintained by the Search Builder Module 404 plug-in. These procedures are called from search session EJB's. They also are not part of the application generation framework and are specific to each generated application.

Exemplary embodiments provide a suite of Runtime Services 608 supplying database, data access layer, business layer, and presentation layer components in order to provide services that are needed during application execution. These services are utilized during application generation and/or by the generated portions of the application for runtime support. These Runtime Services 608 include a presentation service, a security service, an introspector service, a form service, and a script service.

The presentation service is comprised of a Java-based thin client and a JavaServer Pages (JSP)-based web client, depending on the application user's computer configuration. These presentation layers provide similar functionality by converting application logic scripts and forms into an appropriate graphical user interface for presentation to the application user. As part of the presentation services, each client interacts with the security, form and script services. This interaction occurs via web-based Hypertext Transfer Protocol (HTTP) and Simple Object Access Protocol (SOAP). A Java-based thin client presents a graphical user interface as a standard desktop application to the application user. Since the interface is written in Java, it is equally compatible with Windows, UNIX, Linux, and Mac OS X environments. The Java client can be automatically downloaded and executed across the Internet, greatly simplifying application deployment while providing the power of a traditional desktop application.

The runtime security service is responsible for ensuring that only trusted accounts have access to application resources. As discussed above, each application user account can be associated with roles and groups within the system, which are assigned permissions to access various resources, including business logic, data objects, database entities, business components, and methods. The security service is available to every layer of the application architecture, ensuring that any resource access, at any level, is authorized for the current user or account. The system employs a custom authentication service based upon the Java Authentication and Authorization Service (JAAS) specification for validating each service call from the client, whether through standard clients or web services.

The introspector service is an Enterprise JavaBean (EJB) that is published as a web service available to application generation users. This service provides methods to discover and list information regarding services and components currently deployed in the project application. These services are used by the Business Logic Builder Module 412 and the Script Editor and Forms Editor to determine what functions have been deployed to the application. As business and data objects are deployed, they automatically become available to these editors.

The form and script services, including editing, are used by both the application generation tools and by the runtime framework for storing and retrieving forms and scripts using the database. Each form or script is identified with a version number that is automatically incremented whenever the form or script is updated in the database 112. The form and script version numbers are used by the system to implement client-side caching services. For example, when an application user first logs in, the system downloads a list of forms and scripts along with their current version numbers. Whenever the user needs to access a form or script, the system first looks to its cache and compares the version in the cache with the version list downloaded during login and downloads the current form or script anew if needed, ensuring the most current form or script is used. Additionally, form and script services provide the ability to “lock” forms and scripts during editing to prevent other users from modifying a particular form or script until the lock is removed. When a form or script is locked, users and developers can download the current version but cannot check in any updates. This locking mechanism prevents developers from overwriting each other's changes.

As discussed above, the application generation system provides documentation generation methods to get, print, and export reports in the generated application. The document generation services are used by the runtime framework to generate reports, letters, and other application runtime documents, based on the requirements entered using the report builder. The business layer processes each report request and passes that request, along with data retrieved from one or more data transfer objects (DTO's), to the document generation server, i.e. the Report Server 680. Each generated document can be queued for immediate printing, scheduled for batch printing, or returned to the business layer and thereby to the application user for viewing. Each document may be saved in a database and can be associated with another entity stored in the database. The document generation service supports outputting documents in a variety of formats, including Microsoft Word, Microsoft Excel, Adobe PDF, and Rich Text Format (RTF). Access to external documentation generation methods can be provided by means of the new project configuration, where a Document Generation URL is included. This URL is the address that can be used by business components to communication with the Report Server 680 during application execution.

Although preferred embodiments of the present invention have been shown and described, it will be appreciated by those skilled in the art that changes may be made in these embodiments without departing from the principle and spirit of the invention, the scope of which is defined in the appended claims and their equivalents.

1. A computer-based method for generating a software application, comprising:
defining entities, including entity attributes and relationships, for access by the generated software application;
defining database queries to be included in the generated software application for searching application data;
defining application users, roles, and groups for controlling user access to software application generation and/or execution;
defining business logic for directing the processing of the generated software application; and
generating software application code in conformance with the defined business logic.

2. The method according to claim 1, wherein the generated software application is deployable on a J2EE-compliant application server.

3. The method according to claim 1, wherein defining entities includes defining accesses to one or more external databases.

4. The method according to claim 1, wherein the defined entities reside on databases having an entity-attribute-value architecture.

5. The method according to claim 1, wherein defining database queries includes testing the defined queries and presenting the query results to a user.

6. The method according to claim 1, wherein users, roles, and groups can be redefined without stopping the execution of the generated software application.

7. The method according to claim 1, wherein defining business logic includes creating, maintaining, and deploying business objects and client-side scripts, and wherein the business objects represent the business logic of the generated application.

8. The method according to claim 1, wherein defining business logic includes inserting one or more Java code snippets for performing part of the defined business logic.

9. The method according to claim 8, wherein inserting one or more Java code snippets includes generating and displaying Java code before and after the location selected for inserting the one or more Java code snippets.

10. The method according to claim 1, wherein defining business logic includes importing a software wrapper method by means of a single click on a user's computer.

11. The method according to claim 1, wherein pseudo code corresponding to the business logic of the application can be output upon the press of a button.

12. The method according to claim 1, including defining data lookup lists, said lookup lists being available for data population.

13. The method according to claim 12, including creating one or more presentation lists from one or more master lists.

14. The method according to claim 1, including creating formatted record identification strings that conform to existing business rules for creating and assigning identifier values.

15. The method according to claim 1, wherein each of the defining steps include a deploying step whereby the defined feature is deployed for subsequent use during the business logic defining step.

16. The method according to claim 15, wherein the status of the deployment of the defined features is indicated by color.

17. The method according to claim 1, including deploying the generated software application onto an application server.

18. The method according to claim 17, wherein the status of the deployment of the generated software application is indicated by color.

19. The method according to claim 17, including generating and deploying a portion of an entire software application.

20. The method according to claim 17, including automatically generating and deploying tests for testing the life cycle functionality of deployed software application components.

21. The method according to claim 1, wherein generating software application code includes assembling object and/or component information into formatted and concatenated data strings that represent the information as Java source code documents.

22. The method according to claim 1, wherein generating software application code includes replacing tokens in one or more templates residing in an application server with data from an XML document containing object and/or component information to produce the software application code.

23. The method according to claim 1, wherein generating software application code includes replacing tokens in one or more templates residing in an application server with the results of processing data according to rules in, or accessible to, the template(s), to produce the software application code, said data from an XML document containing object or component information.

24. The method according to claim 1, wherein generating software application code includes producing a single Java source code file, representing a single class, for each object and/or component.

25. The method according to claim 1, wherein the generating of software application code is performed without user entry of software code or coded program instructions.

26. The method according to claim 1, wherein the generated software application code comprises Enterprise JavaBean code that will properly execute on an application server conforming to the J2EE specification.

27. The method according to claim 1, wherein the generated software application code is server-independent and can be deployed on multiple servers without modification.

28. The method according to claim 1, including building and displaying a graphical user interface with which a user can interface with the computer-based application generation method.

29. A computer-based method for generating a software application, comprising:
providing an extensible user interface framework for generating a software application; and
providing a computer to:
define entities, including entity attributes and relationships;
define database queries to be included in the generated software application for searching application data, including the attributes of the defined entities;
define application users, roles, and groups for controlling user access to application generation modules and generated application methods;
define business logic for directing the processing of the generated application; and
generate software application code in conformance with the defined business logic.

30. The computer-based method according to claim 29, wherein the computer is further provided to:
define data lookup lists; and
create formatted record identification strings.

31. The computer-based method according to claim 29, wherein the computer is further provided to:
deploy the generated software application onto an application server.

32. The computer-based method according to claim 31, wherein the application server is J2EE compliant.

33. A computer-based system for generating a software application, comprising:
an entity builder module for defining entities, entity attributes, and entity relationships;
a search builder module for defining database queries to be included in the generated software application for searching application data;
a security manager module for defining application users, roles, and groups;
a business logic builder module for defining business logic for directing the processing of the generated application and for generating software application code in conformance with the defined business logic; and
a deployment module for deploying the generated software application code.

34. The system according to claim 33, wherein each module comprises one or more sub-modules.

35. The system according to claim 33, wherein the business logic builder module provides for the creating, maintaining, and deploying of business objects and of client-side scripts, and wherein the business objects represent the business logic of the generated application.

36. The system according to claim 33, wherein the business logic builder module provides for inserting one or more Java code snippets for performing part of the defined business logic.

37. The system according to claim 36, wherein inserting one or more Java code snippets includes generating and displaying Java code before and after the location selected for inserting the one or more Java code snippets.

38. The system according to claim 33, wherein the business logic builder module provides for importing a software wrapper method by means of a single click on a user's computer.

39. The system according to claim 33, wherein generating software application code includes assembling object and/or component information into formatted and concatenated data strings that represent the information as Java source code documents.

40. The system according to claim 33, wherein generating software application code includes replacing tokens in one or more templates residing in an application server with data from an XML document containing object and/or component information to produce the software application code.

41. The system according to claim 33, wherein generating software application code includes replacing tokens in one or more templates residing in an application server with the results of processing data according to rules in, or accessible to, the template(s), to produce the software application code, said data from an XML document containing object or component information.

42. The system according to claim 33, wherein generating software application code includes producing a single Java source code file, representing a single class, for each object and/or component.

43. The system according to claim 33, wherein the generated software application is deployable on a J2EE-compliant application server.

44. The system according to claim 33, including:
a list builder module for defining table lookup lists; and
an identification builder module for creating formatted record identification strings.

45. A computer-based system for generating a software application, comprising:
a graphical user interface for selecting software application generation options and for entering data; and
a computer configured to:
define entities, including entity attributes and relationships;
define database queries to be included in the generated software application;
define application users, roles, and groups;
define business logic for directing the processing of a software application; and
generate software application code to perform the defined business logic.

46. The computer-based system according to claim 45, wherein the computer is further configured to:
define data lookup lists; and
create formatted record identification strings.

47. The computer-based system according to claim 45, wherein the computer is further configured to deploy the generated software application onto one or more application servers.

48. The computer-based system according to claim 47, wherein the one or more application servers are J2EE compliant.

49. The computer-based system according to claim 45, wherein the computer is configured to automatically generate and deploy tests for testing the life cycle functionality of deployed software application components.

50. A computer software application generation system, comprising a computer system, said computer system including at least one of a software application generation program, a memory, and a processor, wherein the processor is directed by the software application generation program to automatically generate software application code in conformance with a user-specified standard and user-supplied business logic.

51. A computer system having a networked server architecture, comprising:
a client server, said client server providing a graphical interface between an application user and a software application;
an application server, said application server configured to receive one or more generated software applications and further configured to communicate with a client server; and
a database server, said database server comprising at least an enterprise information system, said database server configured to communicate with the application server.

52. The computer system according to claim 51, including a report server, said report server configured to deliver print services, including report generation, to the client server.

53. A system for generating a software application, comprising:
means for defining entities, including entity attributes and relationships;
means for defining database queries to be included in the software application;
means for defining data lookup lists;
means for creating formatted record identification strings;
means for defining application users, roles, and groups; and
means for defining business logic for directing the processing of the generated application.

54. The system according to claim 53, including:
means for generating software application code in conformance with the defined business logic; and
means for deploying the generated software application code onto an application server.

55. The system according to claim 53, wherein the application server is J2EE compliant.

56. A computer-readable medium encoded with software for generating a software application, wherein the software is provided for:
defining entities, including entity attributes and relationships;
defining database queries to be included in the generated software application for searching application data;
defining application users, roles, and groups;
defining business logic for directing the processing of the generated application;
generating software application code for performing the business logic on a computer; and
deploying the generated software application code onto an application server.

57. The computer-readable medium according to claim 56, wherein the defining of business logic includes creating, maintaining, and deploying business objects and client-side scripts, and wherein the business objects represent the business logic of the generated application.

58. The computer-readable medium according to claim 56, wherein the defining of business logic includes inserting one or more Java code snippets for performing part of the defined business logic.

59. The method according to claim 58, wherein inserting one or more Java code snippets includes generating and displaying Java code before and after the location selected for inserting the one or more Java code snippets.

60. The computer-readable medium according to claim 56, wherein the defining of business logic includes importing a software wrapper method by means of a single click on a user's computer.

61. The computer-readable medium of claim 56, wherein the software is further provided for
defining data lookup lists; and
creating formatted record identification strings.

62. A computer program product, which, when executed by a computer, implements a software application generator by performing the steps of:
presenting a graphical user interface for selecting application generation options and for entering data;
defining entities, including entity attributes and relationships;
defining database queries to be included in the software application;
defining application users, roles, and groups;
defining business logic for directing the processing of the generated application;
generating software application code for performing the business logic on a computer; and
deploying the generated software application code onto an application server.

63. A computer-based method for generating a software application, comprising:
defining entities, including entity attributes and relationships;
defining database queries to be included in the software application for searching application data, including the attributes of the defined entities;
defining application users, roles, and groups for controlling user access to application generation and/or application execution;
defining business logic for directing the processing of the generated application;
generating software application code in conformance with the defined business logic, wherein the generated code is written in Java and is deployable on a J2EE-compliant application server.

64. A computer-based method for generating a software application, comprising:
defining entities for access by the generated software application;
defining search queries to be included in the generated software application for searching the defined entities, attributes, and/or relationships;
defining data lookup lists, said lookup lists being available for populating the defined entities;
creating formatted record identification strings for creating and assigning identifier values to the defined entities;
defining application users, roles, and groups for controlling user access to software application generation and/or execution;
defining business logic for directing the processing of the generated application; and
generating software application code in conformance with the defined business logic.
